(19) United States
(12) Patent Application Publication
(10) Pub. No.: US 2007/0127903 A1
(43) Pub. Date: Jun. 7, 2007

(54) Photographic apparatus, method of controlling photographic apparatus, and recording medium

(75) Inventors: Kazuo Nomura, Suwa (JP); Michihiro Nagaishi, Suwa (JP); Megumi Sando, Suwa (JP); Hiroki Masuzawa, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/563,727

(22) Filed: Nov. 28, 2006

(30) Foreign Application Priority Data
Nov. 29, 2005 (JP) 2005-343769
Jan. 11, 2006 (JP) 2006-003541
Jan. 13, 2006 (JP) 2006-006681
Jan. 16, 2006 (JP) 2006-007123

(51) Int. Cl. G03B 17/00

(52) U.S. Cl. 396/52

(57) ABSTRACT

A photographic apparatus includes a shooting section for performing shooting based on an operation of an operation part for instructing shooting, a tremor detection section for detecting a tremor amount of the shooting section, and a shooting control section for causing detection by the tremor detection section the tremor amount at least one of before and after an operation of the operation part, specifying a hand tremor tendency of a photographer based on the tremor amount, and instructing the execution of a shooting process in accordance with the specified hand tremor tendency.

### BACKGROUND

1. Technical Field

The present invention relates to a technique for obtaining a less jittery photographic shot image.

2. Description of the Related Art

Some cameras are provided with a jitter amount detection function, which compares an amount of jitter detected after a full-stroke operation of a shutter button with an allowable amount of jitter, changes the mode from a normal shooting mode to a jitter reduction mode for changing the allowable amount of jitter to a lower value if the jitter amount is greater than the allowable amount, and performs shooting when the jitter amount becomes lower than the allowable jitter amount (see, for example, JP-A-8-320511). Further, there are some cameras of this kind, which perform shooting with a timing delayed for a predetermined period of time from the timing with which a local maximum value of the waveform of the jitter amount is detected after the full stroke operation of the shutter button (see, for example, JP-A-5-107622).

However, since the former cameras perform shooting when the jitter amount becomes lower than the allowable jitter amount irrespective of whether or not the jitter amount converges, even if the jitter amount is going to converge later, shooting may be performed before it has converged, which prevents effective shooting of a less jittery image. Further, when the jitter does not converge but is generated constantly, the time-lag before shooting becomes long since shooting is not performed until it moves to the jitter reduction mode.

Still further, since the latter cameras perform shooting based on the timing with which the local maximum value of the waveform of the jitter amount is detected irrespective of whether or not the jitter amount converges, shooting is not allowed with the timing with which the jitter has converged.

### SUMMARY

An object of the invention is to simply specify the tendency of hand tremor of the photographer to allow shooting of an image with reduced jitter in a photographic apparatus, a method of controlling the photographic apparatus and a recording medium.

To address the above problems, a photographic apparatus is provided including a shooting section for performing shooting based on an operation of an operation part for instructing shooting, a tremor detection section for detecting a tremor amount of the shooting section, and a shooting control section for causing detection by the tremor detection section the tremor amount at least one of before and after an operation of the operation part, specifying a hand tremor tendency of a photographer based on the tremor amount, and instructing the execution of a shooting process in accordance with the specified hand tremor tendency. Accordingly, since the hand tremor tendency of the photographer is specified based on the tremor amount at least one of before and after the operation of the operation part for instructing the shooting operation, the hand tremor tendency of the photographer can easily be specified, and since the shooting process in accordance with the specified hand tremor tendency is performed, an image with reduced jitter can be shot.

In the above configuration, it is preferable that the shooting control section compares the tremor amount before the operation of the operation part with a predetermined threshold value, and specifies whether or not the hand tremor tendency of the photographer is a converging tendency in accordance with the result of the comparison. According to the present configuration, the hand tremor tendency of the photographer can simply be specified compared to the case in which a forecasting calculation for predicting the hand tremor tendency is performed.

Further, in the above configuration, a configuration in which the shooting control section compares the tremor amounts before and after the operation of the operation part with each other, and specifies whether or not the hand tremor tendency of the photographer is a converging tendency in accordance with the result of the comparison is preferable. According also to the present configuration, the hand tremor tendency of the photographer can simply be specified compared to the case in which a forecasting calculation for predicting the hand tremor tendency is performed.

Further, in the above configuration, the photographic apparatus is configured to be able to store information representing the specified hand tremor tendency of the photographer, and the shooting control section preferably has a configuration for, in response to the information being stored, instructing the execution of the shooting process in accordance with the hand tremor tendency in the stored information. According to the present configuration, there is no need for performing a process for specifying the hand tremor tendency of the photographer for every shooting operation, thus simplifying the shooting operation.

Further, in the above configuration, the shooting control section preferably has a configuration which, in response to specifying that the hand tremor tendency of the photographer is a converging tendency, and in response to the tremor amount after the operation of the operation part nearly reaching the tremor amount before the operation of the operation part, instructs the shooting section to execute shooting. According to the present configuration, shooting can be performed immediately with the timing when the hand tremor tendency has converged, thus suppressing the time lag, and it becomes possible to shoot a less jittery image with appropriate shooting conditions.

Further, in the above configuration, the shooting control section preferably has a configuration for, in response to specifying that the hand tremor tendency of the photographer is a non-converging tendency, obtaining shooting conditions that are set to one of automatic and manual, and shooting conditions capable of reducing the effect of the tremor, and instructing the shooting section to shoot with severer shooting conditions out of the obtained shooting conditions. According to the present configuration, since the shooting can be performed immediately with the shooting conditions capable of avoiding jitter, a less jittery image can be shot without a time lag.

In the above configuration, the shooting control section is preferably configured to include a hand tremor tendency specifying section for specifying the hand tremor tendency of the photographer based on the tremor amount before the operation of the operation part, and a storage section for pre-storing hand tremor tendency information representing the hand tremor tendency of the photographer, the photographic apparatus is configured to be able to select a first priority mode and a second priority mode. In the first priority mode, the hand tremor tendency information stored in the storage section is given priority over the specifying result of the hand tremor tendency specifying section, and the shooting process is executed in accordance with the hand tremor tendency represented in the hand tremor tendency information. In the second priority mode, the specifying result of the hand tremor tendency specifying section is given priority over the hand tremor tendency information stored in the storage section, and the shooting process is executed in accordance with the hand tremor tendency represented by the specifying result.

According to the present configuration, since the hand tremor tendency of the photographer is specified based on the tremor amount before the operation of the operation part, the hand tremor tendency of the photographer can simply be specified, and further, an appropriate shooting process is performed in accordance with the hand tremor tendency, thus a less jittery shot image can be obtained. Further, the hand tremor tendency information for representing the hand tremor tendency of the photographer is pre-stored, and which one of the hand tremor tendency information and the hand tremor tendency specified by the hand tremor tendency specifying means is given priority can be selectively determined, in the case in which unusual hand tremor different from the usual hand tremor may be caused because of, for example, a poor standing point when shooting or a bad health condition, the photographer can select the first priority mode to perform shooting in accordance with the hand tremor tendency represented by the hand tremor tendency information (namely usual hand tremor tendency) irrespective of the specifying result of the hand tremor tendency specifying means.

Further, if the photographer is temporarily switched by lending the photographic apparatus to a third person, the photographer can select the second priority mode to perform a shooting process in accordance with the hand tremor tendency specified by the hand tremor tendency specifying section irrespective of the hand tremor tendency information. As described above, even in the case in which the conditions of the photographer have changed or the case in which the photographer has temporarily been switched to another photographer, the shooting process corresponding to the original hand tremor tendency of the present photographer can be executed.

Further, in the above configuration, a configuration further including a hand tremor tendency information generation section for comparing the tremor amounts before and after the operation of the operation part with each other to specify the hand tremor tendency of the photographer, and for pre-generating the hand tremor tendency information is preferable. According to the present configuration, since the hand tremor tendency of the photographer is specified by comparing the tremor amounts before and after the operation part is operated, the hand tremor tendency can be more precisely specified than the hand tremor tendency specifying section.

Further, in the above configuration, a configuration in which the hand tremor tendency is categorized into two: a first hand tremor tendency that the hand tremor of the photographer converges on a tremor amount so small as to cause no conspicuous jitter on a shot image after operation of the operation part; and a second hand tremor tendency that the hand tremor of the photographer does not converge on a tremor amount so small as to cause no conspicuous jitter on a shot image after operation of the operation part is preferable. According to the present configuration, the hand tremor tendency of the photographer is specified as either one of the first and the second hand tremor tendencies, and whether or not the hand tremor of the photographer becomes smaller after the operation of operation part is specified. Therefore, by providing an interval from the operation of the operation part, whether shooting without jitter is possible or not can be specified.

Further, in the above configuration, a configuration is preferable that in response to the hand tremor tendency of the photographer being the first hand tremor tendency, shooting is commenced in response to the tremor amount having converged after the operation of the operation part. According to the present configuration, shooting can be performed immediately with the timing when the hand tremor has converged, thus suppressing the time lag, and it becomes possible to perform shooting of a less jittery image.

Further, in the above configuration, a configuration which in response to the hand tremor tendency of the photographer being the second hand tremor tendency, shooting is commenced with the shooting conditions including exposure time, aperture value, and sensitivity changed to the shooting conditions hardly causing jitter on the shot image is preferable. According to the present configuration, since the shooting can be performed immediately with the shooting conditions that hardly cause jitter, a less jittery image can be shot without a time lag.

In the above configuration, the shooting section performs automatic focus adjustment in response to a semi-holding-down operation of the operation part, and performs shooting after a full-holding-down operation of the operation part, the shooting control section preferably has a configuration of obtaining the tremor amount by the tremor detection section at least one of before and after the semi-holding-down operation of the operation part, specifying the hand tremor tendency of the photographer based on the tremor amount, and in response to the full-holding-down of the operating part, instructing to perform the shooting process in accordance with the specified hand tremor tendency. According to the present configuration, the tremor amount of at least one of before and after the semi-holding-down of the shutter button is obtained, and hand tremor tendency of the photographer is specified based on the tremor amount, and if the shutter button is fully held down, the shooting process in accordance with the specified hand tremor is performed. Therefore, the hand tremor tendency of the photographer can easily be specified, and the shooting process in accordance the specified hand tremor tendency is executed. Thus, a less jittery image can be shot.

Further, in the above configuration, a configuration in which the shooting control section compares the tremor amounts before and after the semi-holding-down of the shutter button with each other, and specifies whether or not the hand tremor tendency of the photographer is a converging tendency in accordance with the result of the comparison is preferable. According to the present configuration, the hand tremor tendency of the photographer can simply be specified compared to the case in which forecasting calculation for predicting the hand tremor tendency is performed.

Further, in the above configuration, the shooting control section preferably has a configuration of judging the hand tremor tendency of the photographer to accumulate information representing the hand tremor tendency for each semi-holding-down operation of a shutter button and specifying the hand tremor tendency of the photographer based on the accumulated information. According to the present configuration, since the information representing the hand tremor tendency of the photographer is accumulated for each semi-holding-down operation which is generally more frequently performed than the full-holding-down operation of the shutter button, the number of samplings can be increased, and since the hand tremor tendency of the photographer is specified based on the sampled information, judgment accuracy can be improved.

In the above configuration, the shooting control section preferably has a configuration for judging whether or not there is a tremor having an amplitude greater than a predetermined amplitude within a predetermined frequency range in the tremor detected by the tremor detection section, specifying the hand tremor tendency of the photographer based on the judgment result, and instructing to perform the shooting process in accordance with the specified hand tremor tendency. According to the present configuration, whether or not there is a tremor with an amplitude greater than a predetermined amplitude within a predetermined frequency range in the tremor detected by the tremor detection section is judged, and the hand tremor tendency of the photographer is specified based on the result of the judgment, and the shooting process according to the specified hand tremor tendency is performed, the hand tremor tendency of the photographer can be simply and quickly specified without performing a forecast calculation for estimating the hand tremor tendency. Thus, a less jittery image can be shot.

Further, in the above configuration, it is preferable to have a configuration that the shooting control section judges whether or not there is a constant tremor with an amplitude greater than predetermined amplitude of around 10 Hz. According to the present configuration, whether or not the skilled photographer specific tremor constantly exists can be judged, whether the hand tremor tendency of the photographer is skilled photographer specific or unskilled photographer specific is pre-specified, and at the same time, even if the photographer who is a skilled photographer accidentally produces an “unskilled photographer specific” tremor, the frequency of occurrence is low, and accordingly, misjudgment of the photographer as the unskilled photographer can be prevented.

Further, in the above configuration, it is preferable to have a configuration that the shooting control section specifies whether or not the hand tremor tendency of the photographer is a converging tendency, in response to specifying that the hand tremor tendency of the photographer is a converging tendency, and in response to the tremor amount after the operation of the operation part reaching near the tremor amount before the operation of the operation part, instructs the shooting means to execute shooting. According to the present configuration, shooting can be performed immediately with the timing when the hand tremor tendency has converged, thus suppressing the time lag, and it becomes possible to perform shooting of a less jittery image with appropriate shooting conditions.

Further, in the above configuration, it is preferable to have a configuration that the shooting control section specifies whether or not the hand tremor tendency of the photographer is a converging tendency, in response to specifying that the hand tremor tendency of the photographer is a non-converging tendency, obtains shooting conditions set as one of automatically and manually, and shooting conditions capable of reducing the effect of the tremor, and instructs the shooting means to shoot with severer shooting conditions out of the obtained shooting conditions. According to the present configuration, since the shooting can be performed immediately with shooting conditions capable of avoiding jitter, a less jittery image can be shot without a time lag.

Further, a method of controlling a photographic apparatus is provided comprising: detecting a tremor amount at least one of before and after an operation of an operation part for instructing shooting; and specifying a hand tremor tendency of the photographer based on the tremor amount to perform a shooting process in accordance with the specified hand tremor tendency. Accordingly, since the hand tremor tendency of the photographer is specified based on the tremor amount at least one of before and after the operation of the operation part for instructing the shooting operation, the hand tremor tendency can be easily specified, and since the shooting process in accordance with the specified hand tremor tendency is performed, an image with reduced jitter can be shot.

In this case, obtaining a tremor amount at least one of before and after the semi-holding-down operation of the operation part, specifying the hand tremor tendency of the photographer based on the tremor amount, and in response to the full-holding-down of the operating part, instructing to perform the shooting in accordance with the specified hand tremor tendency is preferable.

Further, it is preferable that a tremor amount of the photographer at least at one of before or after the operation of the operation part is detected, whether or not a tremor with an amplitude greater than a predetermined amount within a predetermined frequency range exists in the detected tremor is judged, the hand tremor tendency of the photographer is specified based on the judgment result, and a shooting operation is performed in accordance with the specified hand tremor tendency.

Further, the invention can be applied to the photographic apparatus and the control method thereof, and in addition thereto, can also be applied to an electronic apparatus implementing the photographic apparatus, and further, the invention can be practiced in such a form as setting a control program for practicing the invention ready for downloading via an electric communication network, or storing the program in a computer readable recording medium such as a magnetic recording medium, optical recording medium, or semiconductor recording medium.

### BRIEF DESCRIPTION OF THE DRAWINGS

FIG. 1 is a block diagram showing a configuration of a digital camera according to a first embodiment of the invention.

FIG. 2 is a diagram for explaining the relationship between a frame and axes of jitter.

FIG. 3 is a diagram showing the tendency of hand tremor of an unskilled photographer.

FIG. 4 is a diagram showing the tendency of hand tremor of a skilled photographer.

FIG. 5 is a flowchart showing an operation when a shooting program is executed.

FIG. 6 is a flowchart showing a first shooting process.

FIG. 7 is a flowchart showing a second shooting process.

FIG. 8 is a flowchart showing an operation in a hand tremor tendency specifying mode according to a second embodiment of the invention.

FIG. 9 is a flowchart showing an operation in a hand tremor tendency specifying mode according to a third embodiment of the invention.

FIG. 10 is a block diagram showing a configuration of a digital camera according to a fourth embodiment of the invention.

FIG. 11 is a flowchart of a hand tremor tendency specifying process.

FIG. 12 is a flowchart in a hand tremor tendency information priority mode.

FIG. 13 is a flowchart in an estimation discrimination priority mode.

FIG. 14 is a flowchart showing a shooting process for a skilled photographer.

FIG. 15 is a flowchart showing a shooting process for an unskilled photographer.

FIG. 16 is a diagram showing the tendency of hand tremor of an unskilled photographer.

FIG. 17 is a diagram showing the tendency of hand tremor of a skilled photographer.

FIG. 18 is a flowchart showing an operation when performing a photographer discrimination program according to a fifth embodiment of the invention.

FIG. 19 is a flowchart showing a first shooting process.

FIG. 20 is a flowchart showing a second shooting process.

FIG. 21 is a diagram showing the frequency characteristic of hand tremor of an unskilled photographer.

FIG. 22 is a diagram showing the frequency characteristic of hand tremor of a skilled photographer.

FIG. 23 is a flowchart showing an operation when performing a shooting program according to a sixth embodiment of the invention.

FIG. 24 is a flowchart showing a first shooting process.

FIG. 25 is a flowchart showing a second shooting process.

### DETAILED DESCRIPTION

Embodiments of the invention will hereinafter be explained with reference to the accompanying drawings.

### First Embodiment

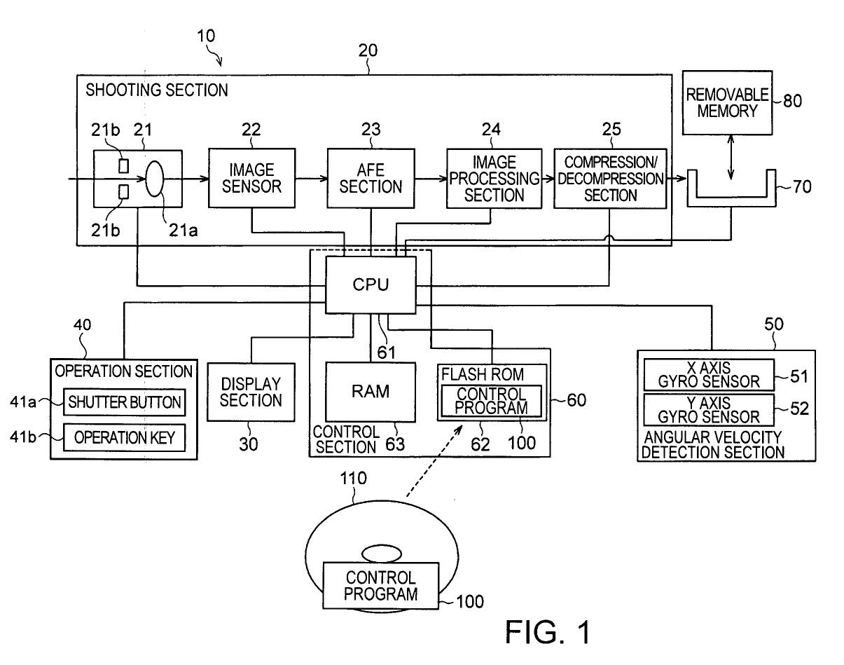

FIG. 1 is a block diagram showing a configuration of a digital camera (imaging device) 10 according to a first embodiment of the invention. The digital camera 10 is provided with an imaging section 20, a display section 30, an operation section 40, an angular velocity detection section 50, a control section 60, an external recording/reproducing section 70, and a removable memory 80, which can be freely attached and detached.

The imaging section 20 includes an optical system 21, an image sensor 22, an analog front-end (AFE) section 23, an image processing section 24, and a compression/decompression section 25. The optical system 21 is mainly composed of a plurality of lenses 21a and an aperture 21b, and either of the plurality of lenses 21a and the aperture 21b are driven under the control of the control section 60, thereby imaging an object on an acceptance surface of the image sensor 22.

The image sensor 22 is an imaging device provided with photoelectric transducers and charge-transfer devices such as charge coupled devices (CCD) discretely disposed in a two-dimensional space, and a so-called CCD image sensor, a CMOS image sensor, or the like is applied thereto. Under control of the control section 60, the image sensor 22 stores the charge, which is obtained by photoelectrically converting the object image imaged on the acceptance surface, in every photoelectric transducer for a predetermined period of time to output an electrical signal in accordance with an amount of light received by every photoelectric transducer. It should be noted that the amount of exposure of the image sensor 22 is determined by the F-value of the aperture 21b and the open time of a mechanical shutter not shown but disposed between the optical system 21 and the image sensor 22, and the amount of exposure in shooting is determined based on the shutter speed and the exposure time set by the control section 60. Further, the exposure time of the image sensor 22 can also be adjusted by electrically controlling the charge storage time of the image sensor 22.

The AFE section 23 outputs RAW data by quantizing the electrical signal output from the image sensor 22 into a digital signal with an AD converter, and the image processing section 24 outputs image data by executing an image forming process on the RAW data for forming a color image having shading levels of the three primary colors (RGB), white balance correction, gamma correction, and so on.

The compression/decompression section 25 is for compressing the image data output from the image processing section 24 and also decompressing the compressed image data, and outputs the compressed image data to the external recording/reproducing section 70, and the external recording/reproducing section 70 records the image data to the removable memory 80 under the control of the controlling section 60. Further, the external recording/reproducing section 70 retrieves the compressed image data recorded on the removable memory 80 to output it to the compression/decompression section 25 under the control of the controlling section 60. It should be noted that a semiconductor memory, an optical disk, a magnetic disk, a hard disk, or the like may be employed as the removable memory 80.

The display section 30 is provided with a liquid crystal display, a liquid crystal drive section, and so on, and has a function as an information output section for displaying information such as an operation menu or a shot image under the control of the control section 60. The digital camera 10 is provided with at least a shooting mode for shooting a still image and a reproduction mode for reproducing the still image thus shot as its operation modes, wherein there is displayed on the display section 30 the image, which is now being shot by the shooting section 20, for example, in the shooting mode, or the image of the image data retrieved by the external recording/reproducing section 70 from the removable memory 80 and then decompressed by the compression/decompression section 25 in the reproduction mode. It should be noted that in the present embodiment, there is provided a plurality of shooting modes.

The plurality of shooting modes mainly includes an automatic exposure mode in which the control section 60 calculates the exposure time (the shutter speed) and the aperture value to perform shooting, a shutter priority mode in which the user (the photographer) inputs the exposure time and the control section 60 calculates the aperture value, an exposure priority mode in which the user inputs the aperture value and the control section 60 calculates the exposure time, a program mode in which the user inputs the exposure time and the aperture value, wherein each of the modes is arranged to perform shooting using a self-timer.

The operation section 40 has a plurality of operation parts operated by the user (the photographer), which is provided with a hold-down type of shutter button (the operation part for a shooting instruction) 41a for instructing shooting, an operation key 41b for performing selection of the operation mode or setting of shooting conditions, and so on. Regarding the shutter button 41a, it is configured to be able to detect a full-holding-down condition in which it is held down to the furthest position and a condition in which it is held down in so-called semi-holding-down condition. Further, the operation key 41b is formed of, for example, an arrow key capable of realizing a number of selection operations with a single operation part.

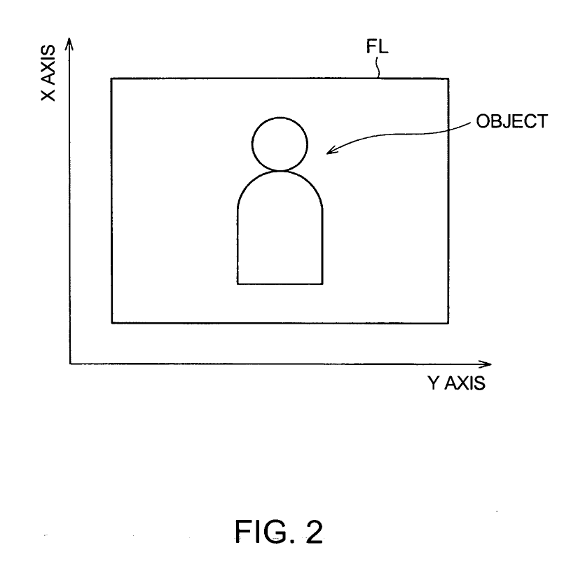

The angular velocity detection section 50 functions as a tremor detection section for detecting a tremor amount of the digital camera 10, and includes an X axis gyro sensor 51 for detecting an angular velocity of the frame FL of the shooting object in an up-and-down direction (hereinafter defined as an X axis) and a Y axis gyro sensor 52 for detecting an angular velocity in a horizontal direction (hereinafter defined as a Y direction) as shown in FIG. 2. This angular velocity detection section 50 outputs angular velocity signals to the control section 60 from the two gyro sensors 51, 52, each of the angular velocity signals having a voltage value corresponding to respective one of the angular velocities of the X axis and the Y axis.

The control section (the shooting control section) 60 functions as a computer (processor) for controlling each section of the digital camera 10, and is provided with a CPU 61 for performing execution of various programs and calculation processes, a rewritable flash ROM (hereinafter simply referred to as a ROM) 62 for storing a control program 100 executed by the CPU 61 and various data, and a RAM 63 functioning as a working area for temporarily storing the operation result or various data of the CPU 61 as shown in FIG. 1.

The control program 100 can be recorded on a computer-readable recording medium 110 such as a magnetic recording medium, an optical recording medium, or a semiconductor recording medium to be delivered, or can be arranged to be downloaded from a delivery server on a communication network. Further, it is also possible to store the control program 100 in the ROM (the storage section) 62 by connecting a personal computer and the present digital camera 10 to each other so as to be able to communicate with each other, and outputting the control program 100 in the recording medium 110 retrieved by the personal computer to the digital camera 10.

The control program 100 described above includes a shooting program for prescribing the shooting mode, and by executing the control program, the control section 60 performs processing such as automatic focus adjustment for driving the lens 21a of the shooting section to focus on the object or automatic exposure (AE) calculation in response to the semi-holding-down of the shutter button 41a, or adjusts the aperture 21b in accordance with the result of the automatic exposure calculation to perform acquisition of the shooting image by the image sensor 22 in response to the full-holding-down of the shutter button 41a.

Incidentally, the shooting mode described above includes a jitter prevention mode in which a shooting process including a process for preventing jitter is executed. In particular, when hand-tremor occurs in response to the user performing a holding-down operation of the shutter button 41a, the hand tremor causes jitter (blur) in the shot image, thus degrading the image quality.

The inventors have collected and studied various human hand tremors generated in the holding-down operations of the shutter button 41a to obtain an effective method for preventing the jitter in the shot image caused by the hand tremor, and as a result, they have obtained the knowledge that the tendency of the hand tremor (hereinafter referred to as “a hand tremor tendency”) is roughly divided into two as follows. That is, the knowledge is that the hand tremor tendency is divided into two tendencies: one is a hand tremor tendency α which is caused when a person unused to shooting (hereinafter referred to as “an unskilled photographer”) performs the holding-down operation of the shutter button 41a; the other is a hand tremor tendency β which is caused when a skilled person used to shooting (hereinafter referred to as “a skilled photographer”) performs the holding-down operation of the shutter button 41a.

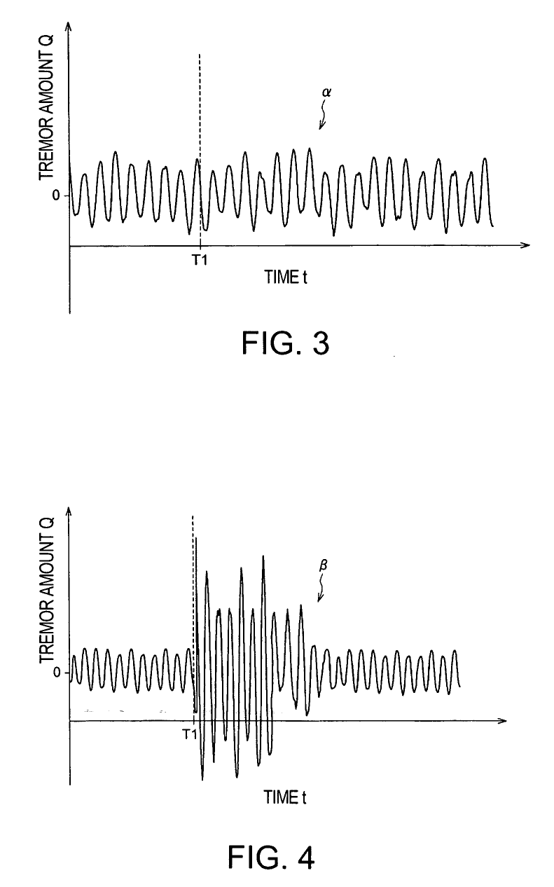

FIG. 3 is a diagram showing the hand tremor tendency α of unskilled photographers, and FIG. 4 is a diagram showing the hand tremor tendency β of skilled photographers. Further, in these drawings, time T1 denotes holding-down timing with which the shutter button 41a is held down.

From a comparison between these drawings, it has been found that there are following differences between the hand tremor tendency α of unskilled photographers and the hand tremor tendency β of skilled photographers.

It has been found that in the case with unskilled photographers, as shown in FIG. 3, there is a tendency that the tremor amount Q hardly varies around the timing T1 with which the shutter button 41a is held down, while in the case with skilled photographers, as shown in FIG. 4, there is a tendency α that although the tremor amount Q increases right after the timing T1 with which the shutter button 41a is held-down, the tremor amount Q is less than the case with unskilled photographers with other timing. In other words, it has been found that unskilled photographers have a tendency that the tremor amount Q is large before operation of the shutter button and the tremor amount Q does not converge, while skilled photographers have a tendency that the tremor amount Q is small before operation of the shutter button and the tremor amount Q converges on a smaller value after operation of the shutter than the value before operation of the shutter button.

Therefore, in the present embodiment, as the shooting mode for the jitter prevention mode, a shooting program for discriminating which one of the two hand tremor tendencies α, β the hand tremor corresponds based on the tremor amount Q before operation of the shutter button and making the shooting process be executed in accordance with the discriminated hand tremor tendency is included in the control program 100.

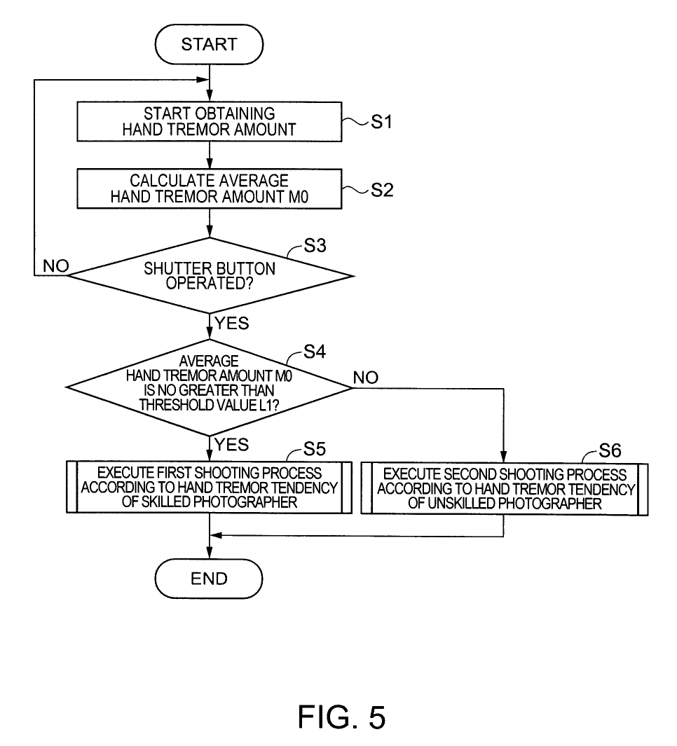

The operation when executing the shooting program will now be explained. FIG. 5 is a flowchart showing the operation in the present case. This shooting program is executed in the shooting mode, and firstly, when moving to the shooting mode, the control section 60 performs a tremor amount obtaining process (step S1). This tremor amount obtaining process is a process in which the control section 60 acquires the angular velocity detection signal from the angular velocity detection section 50, calculates the tremor amount Q (hereinafter referred to as “a hand tremor amount”) corresponding to hand tremor, and obtains the hand tremor amount Q in each of a plurality of time points by repeatedly performing the calculation process a number of times to store them in the RAM 63.

Subsequently, the control section 60 obtains the average value (hereinafter referred to as an average hand tremor amount MO) of the hand tremor amounts Q stored in the RAM 63 by calculation to store it in the RAM 63 (step S2), and subsequently judges whether or not the shutter button 41a is fully held down (step S3).

If the shutter button 41a has not been fully held down (NO in the step S3), namely there is no shooting instruction from the photographer, the control section 60 moves to the process in the step S1, and repeats performing the processes in the steps S1 and S2 until the full-holding-down operation of the shutter button 41a is performed, thus updating the average hand tremor amount MO stored in the RAM 63 to the latest value.

On the other hand, if the full-holding-down operation of the shutter button 41a is performed (YES in the step S3), the control section 60 judges whether or not the average hand tremor amount MO stored in the RAM 63 is equal to or smaller than a threshold L1 set previously (step S4). It should be noted here that the threshold L1 is a criterion measure for judging whether it is the hand tremor amount Q of skilled photographers before operation of the shutter button or the hand tremor amount Q of unskilled photographers before operation of the shutter button, and for example, a value larger than the upper limit value of the hand tremor amount Q of skilled photographers before operation of the button and smaller than the lower limit value of unskilled photographers before operation of the button is applied thereto.

If the average hand tremor amount MO is no greater than L1 (YES in the step S4), the control section 60 can distinguish that the photographer is a skilled photographer, and accordingly regards the hand tremor tendency of the photographer as substantially the same one as the hand tremor tendency β (FIG. 4) of skilled photographers to execute a first shooting process in accordance with this hand tremor tendency β (step S5).

In contrast, if the average hand tremor amount M0 is greater than L1 (NO in the step S4), the control section 60 can distinguish that the photographer is an unskilled photographer, and accordingly regards the hand tremor tendency of the photographer as substantially the same one as the hand tremor tendency α of unskilled photographers to execute a second shooting process in accordance with this hand tremor tendency α (step S6). The first shooting process and the second shooting process will hereinafter be described in detail.

In the case with the first shooting process, since there is a high possibility that the hand tremor tendency of the photographer becomes a tendency in which the hand tremor amount Q converges (which corresponds to the hand tremor tendency β shown in FIG. 4), shooting is delayed for the convergence of the hand tremor amount Q.

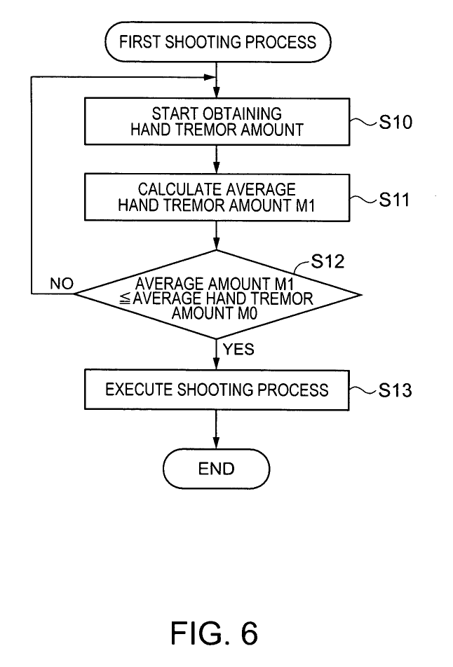

FIG. 6 is a flowchart showing the first shooting process. As shown in the drawing, the control section 60 firstly commences the tremor amount obtaining process to sequentially obtain the hand tremor amount Q after operation of the shutter button (step S10), then obtains the average value (hereinafter referred to as an average hand tremor amount M1) of these hand tremor amounts Q by calculation (step S11), and judges whether or not the average hand tremor amount M1 is equal to or smaller than the average hand tremor amount M0 before operation of the shutter button which is pre-stored (step S12).

In this case, if the average hand tremor amount M1 is larger than the average hand tremor amount M0 (NO in the step S12), the control section 60 moves to the process in the step S10, thus newly obtaining the average hand tremor amount M1, and repeatedly performs the processes in the steps S10 through S12 for judging whether or not this average hand tremor amount M1 is no larger than the average hand tremor amount M0.

In this case, since there is a high possibility that the hand tremor tendency of the photographer becomes a converging tendency (the hand tremor tendency of skilled photographers) after operation of the shutter button, the average hand tremor amount M1 converges on a value no greater than the average hand tremor amount M0 before operation of the shutter button (YES in the step S12), and in this case, the control section 60 performs shooting (step S13) with shooting conditions (the exposure time and the aperture value) automatically set by the control section 60 or manually set by the user. Thus, shooting can be performed with the most suitable conditions with the timing with which the hand tremor amount Q becomes the minimum, thereby a high quality image with less jitter can be shot. The first shooting process is as described hereinabove.

Now, the second shooting process will hereinafter be explained. In the case with the second shooting process, since there is a high possibility that the hand tremor tendency of the photographer becomes a non-converging tendency (which corresponds to the hand tremor tendency α shown in FIG. 3), it is arranged to obtain shooting conditions capable of reducing the effect of the jitter obtained from the hand tremor amount Q, and to perform shooting with severer conditions out of the present conditions and the conditions set automatically.

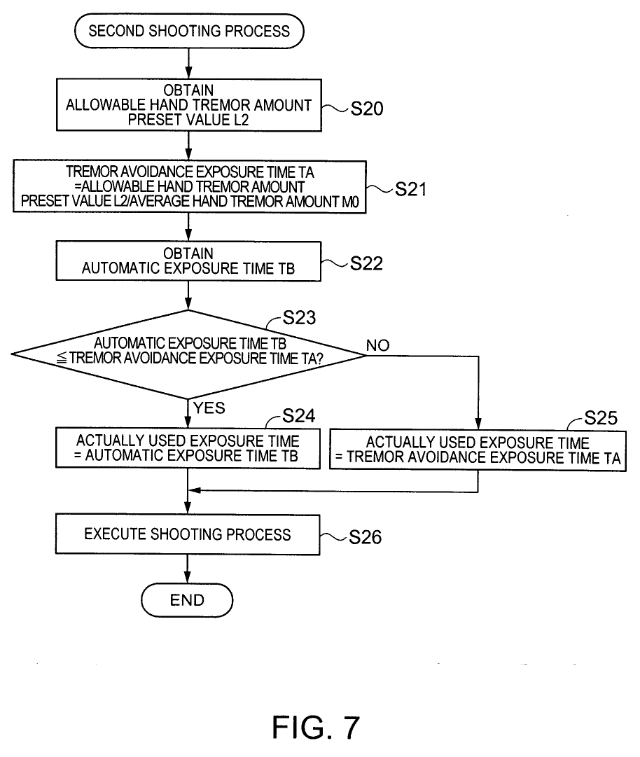

FIG. 7 is a flowchart showing the second shooting process. It should be noted that although the case in which the exposure time out of the shooting conditions is set is exemplified in the present embodiment, the exposure time is not limiting, and, for example, the aperture value can be set.

As shown in FIG. 7, the control section 60 firstly obtains an allowable hand tremor amount preset value L2 previously described in the shooting program (step S20), then divides the allowable hand tremor amount preset value L2 by the stored average hand tremor amount M0, and sets jitter avoidance exposure time TA allowing avoidance of the jitter in accordance with the division value (step S21).

Subsequently, the control section 60 obtains the exposure time (hereinafter referred to as an automatic exposure time) TB used when performing the automatic exposure (step S22), and judges whether or not the automatic exposure time TB is no greater than the jitter avoidance exposure time TA (step S23). Further, if the automatic exposure time TB is no greater than the jitter avoidance exposure time TA (YES in the step S23), the control section 60 sets the exposure time, which is to be actually used, to the automatic exposure time TB (step S24), or if the automatic exposure time TA exceeds the jitter avoidance exposure time TB (No in the step S23), the actually used exposure time is set to the automatic exposure time TA. Thereafter, the control section 60 performs shooting with the shooting conditions including the exposure time thus set as described above (step S25).

As described above, since the shooting is performed with the exposure time no greater than the jitter avoidance exposure time TA allowing jitter avoidance, a less jittery image can be shot even under the condition with relatively large hand tremor amount Q, and further, since the shooting is performed immediately after operation of the shutter button, a delay in the shooting timing (a time lag) can be reliably avoided. The second shooting process is as described hereinabove.

As described above, since whether the hand tremor tendency of the photographer is the tendency (the converging tendency) β of skilled photographers or the tendency (the non-converging tendency) α of unskilled photographers is specified based on the hand tremor amount Q before operation of the shutter button in the present embodiment, the hand tremor tendency of the photographer can be simply and quickly specified without performing a forecasting calculation or the like for forecasting the hand tremor tendency.

Moreover, since in the case in which the hand tremor tendency of the photographer is the tendency β of skilled photographers, the shooting is performed immediately with the timing with which the hand tremor tendency has converged in the present embodiment, it becomes possible to shoot a less jittery image with proper shooting conditions while controlling the time lag. Further, since in the case in which the hand tremor tendency of the photographer is the tendency α of unskilled photographers, the shooting is immediately performed with the shooting conditions to avoid jitter, it becomes possible to shoot a less jittery image without a time lag.

### Second Embodiment

The digital camera 10 according to a second embodiment is substantially the same as the digital camera 10 according to the first embodiment except the point that the digital camera 10 according to the second embodiment has a hand tremor tendency specifying mode for pre-specifying the hand tremor tendency of the user (the photographer), and performs shooting in accordance with the hand tremor tendency specified in this mode. Therefore, the hand tremor tendency specifying mode will hereinafter be explained in detail.

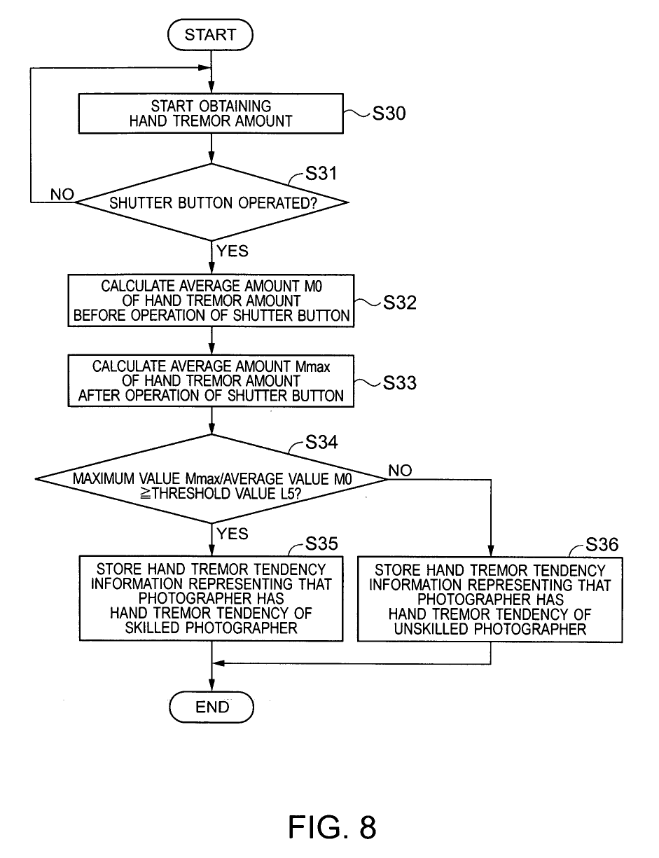

FIG. 8 is a flowchart showing the operation in the hand tremor tendency specifying mode. It should be noted that the hand tremor tendency specifying mode is a mode in which the user is requested to perform an empty shutter operation, and the hand tremor tendency of the photographer is specified in accordance with a variation characteristic between the hand tremor amounts Q before and after that operation.

When the hand tremor tendency specifying mode is selected by the user, the control section 60 commences the tremor amount obtaining process (step S30). Subsequently, the control section 60 judges whether or not the shutter button 41a is fully held down (step S31), and moves to the process in the step S30 in the case with the negative result, thus continuing the tremor amount obtaining process until the shutter button 41a is fully held down.

On the other hand, in the case in which the full-holding-down operation of the shutter button 41a is performed, after obtaining the average value (the average hand tremor amount M0) of the hand tremor amounts Q before the shutter operation by calculation and storing it in the RAM 63 (step S32), the control section 60 obtains the maximum value Mmax of the hand tremor amount Q in a predetermined period of time after the operation of the shutter button (step S33).

Subsequently, the control section 60 judges whether or not a value X obtained by dividing the maximum value Mmax by the average hand tremor amount M0 is no smaller than a predetermined threshold value L5 (step S34). It should be noted here that since in the case with unskilled photographers, the hand tremor amount Q hardly changes before and after the shutter operation (FIG. 3), the value X is expected to have a value nearly equal to one, and on the other hand, since in the case with skilled photographer, the hand tremor amount Q increases immediately after operation of the shutter (FIG. 4), it is expected that the value X takes a larger value than one. Therefore, by setting a value with which the typical value X can be distinguished between the unskilled photographers and the skilled photographers as described above to the threshold value L5, whether the photographer has the hand tremor tendency of the skilled photographers or the hand tremor tendency of the unskilled photographers can be specified.

Subsequently, if the value X is equal to or greater than the threshold value L5 (YES in the step S34), the control section 60 judges that the photographer is a skilled photographer, and stores hand tremor tendency information representing that the photographer has the hand tremor tendency of the skilled photographers in the RAM 63 or the ROM 62 (step S35), or if the value X is smaller than the threshold value L5 (NO in the step S34), it is judged that the photographer is the unskilled photographer (step S36), and the hand tremor tendency information representing that the photographer has the hand tremor tendency of the unskilled photographers is stored in the RAM 63 or the ROM 62. Thus, the hand tremor tendency information capable of specifying the hand tremor tendency of the photographer is stored. The operation in the hand tremor tendency specifying mode is as described hereinabove.

When the hand tremor tendency information is stored, in the case with the shooting mode, the control section 60 retrieves the hand tremor tendency information, and in accordance with the information, performs the first shooting process (see FIG. 6) described in the first embodiment to perform shooting in the case in which the photographer has the hand tremor tendency of skilled photographers, or performs the second shooting process (see FIG. 7) to perform shooting in the case in which the photographer has the hand tremor tendency of unskilled photographers.

As explained above, since in the present embodiment, the hand tremor amounts Q by the photographer before and after the shutter operation are compared, and in accordance with the results of the comparison, whether the hand tremor tendency of the photographer is the tendency (converging tendency) β of skilled photographers or the tendency (non-converging tendency) α of unskilled photographers is specified, the hand tremor tendency of the photographer can be more accurately specified, and further, the hand tremor tendency can be more simply discriminated compared to the case in which the forecasting calculation or the like for forecasting the hand tremor tendency is performed.

Further, since in the present embodiment, the information for representing the specified hand tremor tendency of the photographer is stored, and the shooting process in accordance with the stored information is performed, similarly to the first embodiment, it becomes possible not only to reliably shoot a less jittery image while controlling the time lag, but also to eliminate necessity of performing a process of specifying the hand tremor tendency of the photographer for every shooting, thus making it possible to simplify the shooting process.

### Third Embodiment

The digital camera 10 according to a third embodiment is substantially the same as the digital camera 10 according to the first embodiment except the point that the digital camera 10 according to the third embodiment performs a hand tremor tendency specifying process for specifying the hand tremor tendency of the user (the photographer) in accordance with the hand tremor amount Q in the past shooting operation, and the hand tremor tendency specifying process will hereinafter be explained in detail.

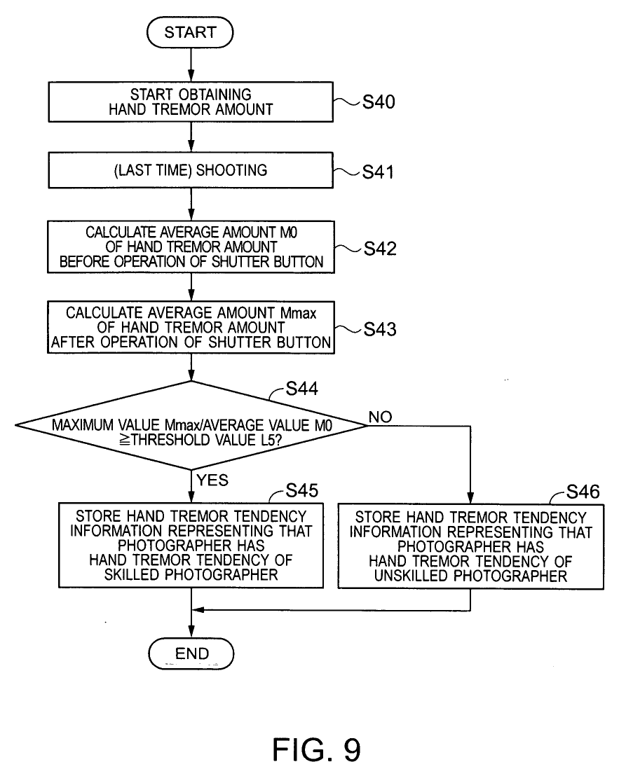

FIG. 9 is a flowchart showing a hand tremor tendency specifying process. It is assumed that the hand tremor specifying process is a process executed in the shooting mode, and is executed, for example, in the case in which the hand tremor tendency information representing the tremor amount is not stored, in the case in which a predetermined period of time has elapsed from the last storing of the hand tremor tendency information, or in the case in which commencement of the process is instructed by the user.

Firstly, the control section 60 commences the tremor amount obtaining process (step S40), and performs the shooting process (last shooting) (step S41) if there is a full-holding-down operation of the shutter button 41a. After the shooting process, the control section 60 obtains the average value (the average hand tremor amount MO) of the hand tremor amounts Q prior to the shutter button operation by calculation (step S42), and obtains the maximum value Mmax of the hand tremor amount Q after operation of the shutter button (step S43).

Subsequently, similarly to the second embodiment, the control section 60 obtains the value X obtained by dividing the maximum value Mmax by the average hand tremor amount MO, judges whether or not the value X is no smaller than the predetermined threshold value L5 (step S44), and if it is no less than L5 (YES in the step S44), the hand tremor tendency information representing that the photographer has the hand tremor tendency of skilled photographers is stored in the RAM 63 or the ROM 62 (step S45), or if the value X is smaller than the threshold value L5 (NO in the step S44), the hand tremor tendency information representing that the photographer has the hand tremor tendency of unskilled photographers is stored in the RAM 63 or the ROM 62 (step S46). Thus, the hand tremor tendency information capable of specifying the hand tremor tendency of the photographer is stored. The operation in the hand tremor tendency specifying process is as described hereinabove.

Further, when the shooting instruction is subsequently presented by operating the shutter button, the control section 60 retrieves the hand tremor tendency information, and in accordance with the information, performs the first shooting process (see FIG. 6) described in the first embodiment to perform shooting in the case in which the photographer has the hand tremor tendency of skilled photographers, or performs the second shooting process (see FIG. 7) to perform shooting in the case in which the photographer has the hand tremor tendency of unskilled photographers.

Since in the present embodiment, the hand tremor amounts Q before and after the shutter button operation in the actual shooting operation are obtained, and whether the hand tremor tendency of the photographer is the tendency (converging tendency) β of skilled photographers or the tendency (non-converging tendency) α of unskilled photographers is specified based on the comparison result thereof, in addition to the advantages of the second embodiment, special operations such as requiring the user to perform an empty shutter operation can be eliminated. Therefore, it becomes possible only by the user performing an ordinary shooting operation to perform the shooting process in accordance with the hand tremor tendency of the user.

### Fourth Embodiment

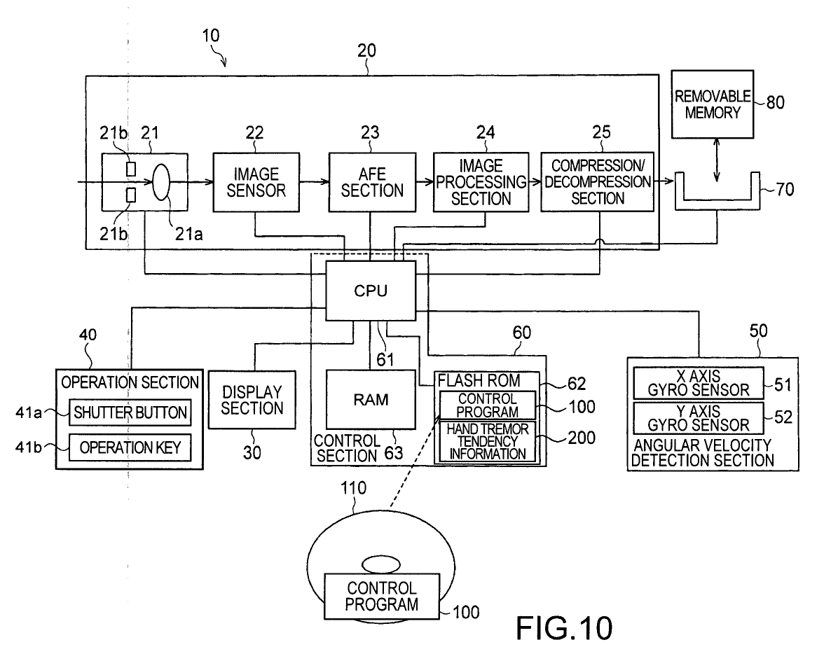

FIG. 10 is a block diagram showing a configuration of a digital camera according to a fourth embodiment. The digital camera 10 is substantially the same as the digital camera 10 according to the first invention except the point that the shooting processes are different from each other, and accordingly, duplicated description will be omitted. In this digital camera 10, based on a plurality of differences found by comparison between the hand tremor tendency α (see FIG. 3) of unskilled photographers and the hand tremor tendency β (see FIG. 4) of skilled photographers, which one of the tendencies the hand tremor tendency of the actual shooting operation should be categorized as is judged, and shooting is performed along the specified hand tremor tendency.

In more detail, there are a number of differences as follows between the hand tremor tendencies α and β. That is, as a first difference, prior to the time point right before the holding-down timing T1 of the shutter button 41a, the hand tremor amount Q is relatively large in the case with unskilled photographers while the hand tremor amount Q is relatively small in the case with skilled photographers.

Further, as a second difference, in the variation of the hand tremor amounts Q before and after the holding-down timing Ti of the shutter button 41a, the hand tremor does not converge even immediately after holding-down the shutter button 41a and relatively large hand tremor amount Q continues in the case with unskilled photographers while the hand tremor amount Q temporarily becomes large immediately after holding-down the shutter button 41a but converges with time to the extent with which a shot image with no jitter at all or no conspicuous jitter can be obtained in the case with skilled photographers.

Further, according to the second difference, it is assumed that when skilled photographers perform shooting, a shot image with no jitter at all or no conspicuous jitter can be obtained by commencing shooting (exposure) after delaying for the elapse of time from the holding-down timing T1 of the shutter button 41a, the time being necessary for the hand tremor amount Q to converge to the extent with which a shot image with no jitter can be obtained.

In contrast, since in the case in which unskilled photographers perform shooting, the hand tremor amount Q does not converge even after elapse of time from the holding-down timing T1 of the shutter button 41a, it is required to perform shooting with the shooting conditions changed so as to minimally allow jitter in the shot image. It should be noted here that exposure conditions include three factors, namely shutter speed, aperture value, and sensitivity.

The shutter speed denotes the exposure time of the image sensor 22, and the aperture value denotes the degree of narrowing-down by the aperture 21b, in other words, the degree of narrowing-down of the effective diameter (the diameter of the light passing therethrough) of the lens 21a. The larger the aperture value is, the larger the effective diameter of the lens 21a becomes to reduce the amount of light received by the imaging devices, and at the same time, increase the depth of field enhancing the area which can be focused on, thereby making it possible to take a clear picture over a long distance. The sensitivity corresponds to the photographic sensitivity, and corresponds to the amplitude of the electrical signal output from the image sensor 22. Therefore, the higher the sensitivity is set, the higher the amplitude of the electric signal is set.

Further, by setting the shutter speed to a high speed and the exposure time to a short period of time, it becomes possible to substantially reduce the hand tremor amount Q in the exposure period and to make the jitter in the shot image less conspicuous. It should be noted that since the higher the shutter speed is set, the smaller the amount of light received by the image sensor 22 becomes, in the case in which the shutter speed is set to a high speed, the amount of light is increased by reducing the aperture value and/or enhancing the sensitivity, thus a high quality shot image with no (or not conspicuous) jitter can be obtained even if the hand tremor is caused when an unskilled photographer performs shooting.

According to the above, in the case in which the hand tremor tendency in a shooting operation is the hand tremor tendency α of unskilled photographers, a shot image with no jitter can be obtained by changing the shooting conditions, and in the case in which it is the hand tremor tendency β of the skilled photographers, a shot image with no jitter can also be obtained by commencing the shooting operation after delaying for the elapse of time with which the tremor amount Q converges from the holding-down timing T1 of the shutter button 41a. As described above, by performing the appropriate shooting process in accordance with the hand tremor tendency, jitter caused in the shot image can be suppressed to make it possible to effectively obtain a high-quality image.

Further, which one of the hand tremor tendency α of unskilled photographers and the hand tremor tendency β of the skilled photographers the hand tremor tendency in the actual shooting operation is categorized can be distinguished as follows based on the first and the second differences between the hand tremor tendency α and the hand tremor tendency β.

That is, according to the first difference described above, whether the hand tremor tendency in shooting operation is the hand tremor tendency α of unskilled photographers or the hand tremor tendency β of skilled photographers can be estimated by discriminating the size of the hand tremor amount Q right before the holding-down timing T1 of the shutter button 41a without detecting the hand tremor amount Q after the shutter button 41a is held down.

Further, according to the second difference described above, by discriminating the range of the variation of the hand tremor amounts Q before and after the holding-down timing T1 of the shutter button 41a, whether the hand tremor tendency in shooting is the hand tremor tendency α of unskilled photographers or the hand tremor tendency β of skilled photographers can be specified.

Accordingly, in the digital camera 10 of the present embodiment, the tremor avoidance mode is selected as the shooting mode, whether the hand tremor tendency of the photographer is the hand tremor tendency α of unskilled photographers or the hand tremor tendency β of skilled photographers is distinguished based on the two discrimination method, namely the discrimination of the hand tremor tendency based on the first difference described above (thereinafter referred to as “tendency estimation discrimination”) and the discrimination of the hand tremor tendency based on the second difference described above (hereinafter referred to as “tendency specifying discrimination”), and in accordance with the hand tremor tendency, the shooting process capable of effectively obtaining a shot image with no jitter is performed.

In this case, although it is sufficient to detect the hand tremor amount Q at least right before the holding-down timing T1 of the shutter button 41a in the tendency estimation discrimination described above, the tendency specifying discrimination described above is based on the second difference described above, and accordingly, it is required to detect the hand tremor amounts Q before and after the holding-down timing T1 of the shutter button 41a, and accordingly a time lag might be caused from when the shutter button 41a is held down to when the hand tremor tendency is specified.

Therefore, in the present embodiment, in the case in which the hand tremor tendency of the photographer is discriminated by the tendency specifying discrimination described above, the discrimination is not performed in the shooting operation, but the hand tremor tendency specifying process for specifying the hand tremor tendency is performed prior to the shooting operation, and the specified hand tremor tendency is pre-stored in the ROM 62 as the hand tremor tendency information 200 (see FIG. 1).

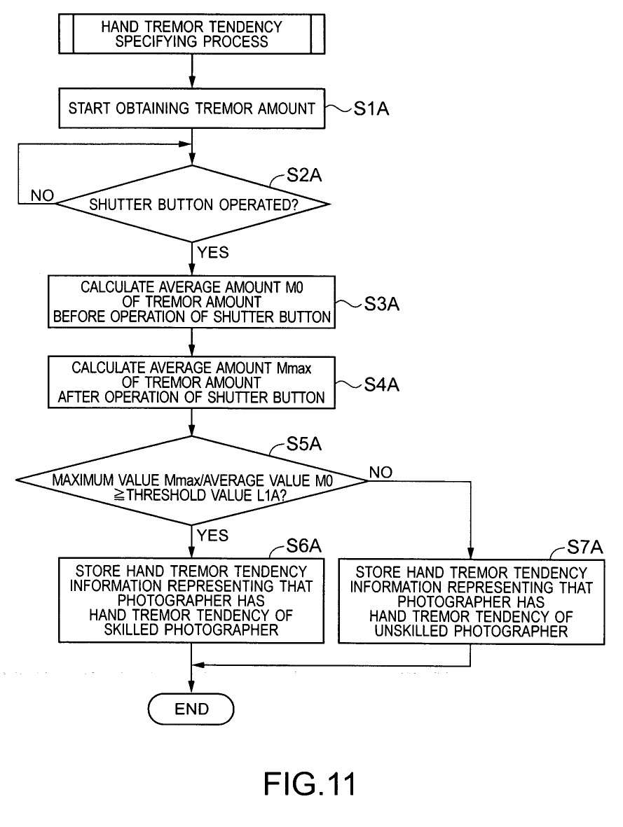

FIG. 11 is a flowchart showing the hand tremor tendency specifying process. This hand tremor tendency specifying process is executed when the shutter button 41a is operated while a normal mode is selected as the shooting mode, or when the shutter button 41a is operated as a simulated operation (the empty shutter operation is performed) for the shooting operation. Specifically, as shown in FIG. 11, the control section 60 firstly activates the angular velocity detection section 50 to commence acquisition of the angular velocity detection signal, thus starting acquisition of the hand tremor amount Q (step S1A) before the shutter button 41a is operated. More specifically, in the step S1A, the control section 60 sequentially acquires the angular velocity detection signal from the angular velocity detection section 50, performs time integration of the angular velocity for every sampling time of the angular velocity detection signal to obtain the tremor angle (degrees) varied in accordance with the hand tremor during the sampling time, defines the tremor angle or an amount of displacement (pixels) calculated based on the tremor angle as hand tremor amount Q, and sequentially stores the hand tremor amount Q obtained for every sampling time in the RAM 63.

Subsequently, the control section 60 judges whether or not the holding-down operation of the shutter button 41a is performed (step S2A) in order for detecting the holding-down operation (full-holding-down operation) of the shutter button 41a, if the holding-down operation is not performed (NO in the step S2A), it returns the process procedure to the step S2A to continue detecting the holding-down operation of the shutter button 41a while acquiring the hand tremor amount Q in order for detecting the hand tremor amounts Q before and after the holding-down operation of the shutter button 41a.

On the other hand, if the holding-down operation of the shutter button 41a is performed (YES in the step S2A), the control section 60 calculates the average value (the average hand tremor amount M0) of the hand tremor amounts Q which have been obtained in a predetermined period of time right before the holding-down timing T1 as the hand tremor amount Q right before the holding-down timing T1 of the shutter button 41a, and stores it in the RAM 63 (step S3A) Subsequently, the control section 60 specifies the maximum value Mmax out of the hand tremor amounts Q which have been obtained in a predetermined period of time right after the holding-down timing T1 of the shutter button 41a as the hand tremor amount Q right after the holding-down timing T1 of the shutter button 41a (step S4A).

Subsequently, the control section 60 divides the maximum value Mmax by the average hand tremor amount M0 to obtain the value X indicating how much the hand tremor increases after the holding-down timing T1 of the shutter button 41a from the holding-down timing T1 in order for specifying the hand tremor tendency in accordance with the variation range of the hand tremor amounts Q before and after the holding-down timing T1 of the shutter button 41a, and judges whether or not the value X is no smaller than a predetermined threshold value L1A (step S5A). This threshold value L1A is a criterion measure for judging whether it is the hand tremor amount Q of skilled photographers before operation of the shutter button or the hand tremor amount Q of unskilled photographers before operation of the shutter button. In detail, in the case with the hand tremor tendency α of unskilled photographers, since the hand tremor amounts Q before and after the operation of the shutter button 41a are almost the same (FIG. 3), the value X described above becomes a value nearly equal to “1,” and in the case with the hand tremor tendency β of skilled photographers, since the hand tremor amount Q increases immediately after the operation of the shutter button 41a from the amount right before the operation (FIG. 4), the value X described above becomes greater than “1,” and the threshold value L1A is set to an intermediate value between them. For example, by setting the value corresponding to the value X, which is obtained when a typical skilled photographer performs shooting, to the threshold L1A, and by comparing the threshold value L1A and the value X in size, whether the hand tremor tendency of the photographer is the hand tremor tendency α of unskilled photographers or the hand tremor tendency β of skilled photographers can be specified.

Therefore, the control section 60 stores the hand tremor tendency information 200 representing that the hand tremor tendency of the photographer is the hand tremor tendency β of skilled photographers in the ROM 62 (step S6A) if the value X is no smaller than the threshold L1A (YES in the step S5A), or stores the hand tremor tendency information 200 representing that the hand tremor tendency of the photographer is the hand tremor tendency α of unskilled photographers in the ROM 62 (step S7A) if the value X is smaller than the threshold value L1A (NO in the step S5A).

According to the hand tremor tendency specifying process, the hand tremor tendency information 200 representing the hand tremor tendency of the photographer is stored in the ROM 62, thus in the shooting operation in the tremor avoidance mode, an appropriate shooting process is quickly executed based on the hand tremor tendency information 200 without detecting the hand tremor.

It should be noted that in the case in which the hand tremor tendency specifying process is executed while, for example, the normal mode is selected as the shooting mode, it is preferable that the hand tremor tendency specifying process is not executed in response to the operation of the shutter button 41a in the shooting operation, but the hand tremor amount Q is detected and temporarily stored in the RAM 63 in response to the operation of the shutter button 41a, and the hand tremor tendency of the photographer is specified based on the hand tremor amount Q stored in the RAM 63 to generate the hand tremor tendency information 200 after the shooting operation is completed.

Incidentally, in the tendency specifying discrimination, by pre-storing the hand tremor tendency information 200, or in the tendency estimation discrimination, since it is sufficient to detect the hand tremor amount Q at least to the time point right before the holding-down timing T1 of the shutter button 41a, the hand tremor tendency of the photographer can quickly be discriminated in shooting operations in either discrimination.

However, if the configuration which uses either one of the tendency specifying discrimination and the tendency estimation discrimination for the discrimination of the hand tremor tendency is adopted, the following problem arises.

That is, if the tendency discrimination of the hand tremor of the photographer is limited to the tendency specifying discrimination described above, in other words, if the hand tremor tendency is discriminated based on the hand tremor tendency information 200 stored previously, if the owner of the digital camera 10 lends the digital camera 10 to another person, for example, the hand tremor tendency of the hand tremor tendency information 200 and the hand tremor tendency in the actual shooting operation might be different from each other, thus the appropriate shooting process for eliminating jitter in the shot image might not be performed.

On the other hand, if the tendency discrimination of the hand tremor of the photographer is limited to the tendency estimation discrimination described above, in the case in which a skilled photographer accidentally produces large amount of hand tremor before the holding-down operation of the shutter button 41a because of a bad health condition or by performing shooting with an unstable posture, or on the contrary, in the case in which an unskilled photographer accidentally produces a small amount of hand tremor before the holding-down operation of the shutter button 41a, the hand tremor tendency is mistakenly discriminated to prevent an appropriate shooting process corresponding to the hand tremor after operation of the shutter button 41a.

Therefore, in the present embodiment, the tendency discrimination based on the hand tremor tendency information 200 together with the tendency estimation discrimination and to give priority to either one of the discrimination results of the tendency discriminations in the tremor avoidance mode as one of the shooting modes. Specifically, the tremor avoidance mode is provided with two modes: a hand tremor tendency information priority mode (a first priority mode); and an estimation discrimination priority mode (a second priority mode), so as to be selected by the user with, for example, the operation key 41b described above. The hand tremor tendency information priority mode is a mode for giving priority to the result of the tendency discrimination based on the hand tremor tendency information 200 described above over the result of the tendency estimation discrimination, while the estimation discrimination priority mode is a mode for giving priority to the result of the tendency estimation discrimination described above over the result of the tendency discrimination based on the hand tremor tendency information 200.

Hereinafter, the operation in the hand tremor tendency information priority mode and the operation in the estimation discrimination priority mode will be explained in sequence.

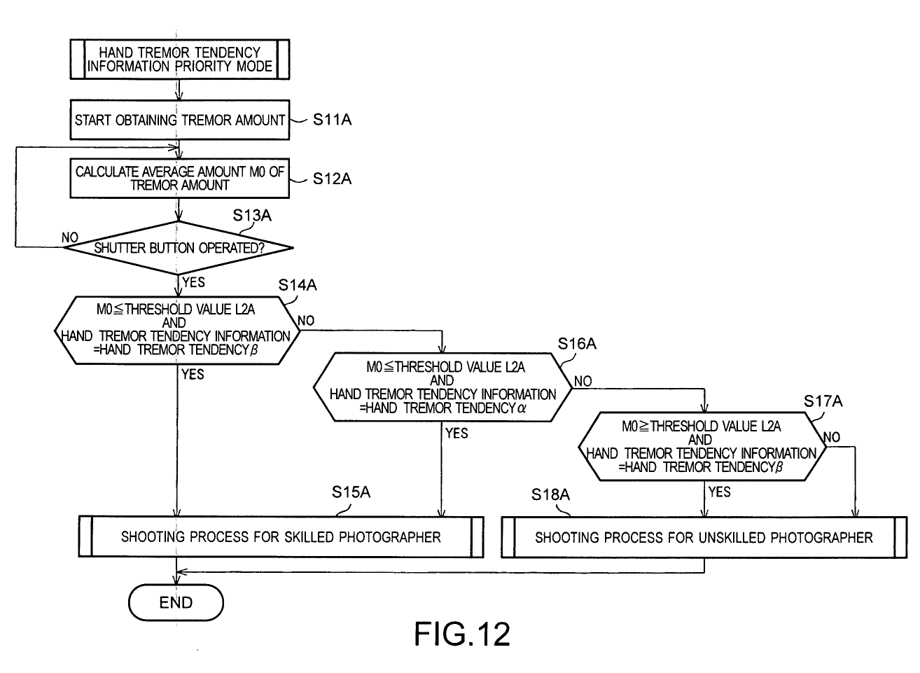

FIG. 12 is a flowchart showing the operation in the hand tremor tendency information priority mode. As shown in this drawing, if the hand tremor tendency information priority mode is selected, the control section 60 activates the angular velocity detection section 50 to commence the acquisition of the angular velocity detection signal, thus starting the acquisition of hand tremor amount Q to sequentially store them in the RAM 63 (step S11A) in order for performing the estimation discrimination described above based on the hand tremor amount Q right before the holding-down timing T1 of the shutter button 41a.

Subsequently, the control section 60 obtains the average value (hereinafter referred to as an average hand tremor amount M0) of the hand tremor amounts Q stored in the RAM 63 by calculation to store it in the RAM 63 (step S12A) for each elapse of a constant period of time, and subsequently judges whether or not the shutter button 41a is fully held down (step S13A) If the shutter button 41a has not been fully held down (NO in the step S13A), namely there is no shooting instruction from the photographer, the control section 60 repeats performing the process in the step S12A until the full-holding-down operation of the shutter button 41a is performed, thus updating the average hand tremor amount MO stored in the RAM 63 to the latest value.

On the other hand, if the full-holding-down operation of the shutter button 41a is performed (YES in the step S13A), the control section 60 judges whether or not the average hand tremor amount M0 stored in the RAM 63 is no greater than the predetermined threshold value L2A and the hand tremor tendency information 200 stored in the ROM 62 represents the hand tremor tendency β of skilled photographers (step S14A). It should be noted here that the threshold value L2A is a criterion measure for judging whether the average hand tremor amount MO right before operation of the shutter button is the hand tremor amount Q of skilled photographers before operation of the shutter button or the hand tremor amount Q of unskilled photographers before operation of the shutter button, and for example, a value larger than the upper limit value of the hand tremor amount Q of skilled photographers before operation of the button and smaller than the lower limit value of the hand tremor amount Q of unskilled photographers before operation of the button is applied thereto.

If the average hand tremor amount M0 is no greater than the threshold value L2A and the hand tremor tendency information 200 represents the hand tremor tendency β of skilled photographers (YES in the step S14A), the control section 60 performs the shooting process for skilled photographers described later (step S15A) since both of the average hand tremor amount M0 right before operation of the shutter button and the hand tremor tendency information 200 represent the hand tremor tendency β of skilled photographers.

On the other hand, if the average hand tremor amount M0 is no smaller than the threshold value L2A or the hand tremor tendency information 200 is not the hand tremor tendency β of skilled photographers (NO in the step S14A), the control section 60 judges whether or not the average hand tremor amount MO is no smaller than the threshold value L2A and the hand tremor tendency information 200 represents the hand tremor tendency β of skilled photographers (step S16A). Further, if the average hand tremor amount M0 is no smaller than the threshold value L2A and the hand tremor tendency information 200 represents the hand tremor tendency β of skilled photographers (YES in the step S16A), in spite of the fact that the hand tremor tendency α of unskilled photographers is suggested according to the average hand tremor amount M0 right before operation of the shutter button, the control section 60 moves the process procedure to the step Sb5 described above to perform the shooting process for skilled photographers in order to give priority to the hand tremor tendency represented by the hand tremor tendency information 200.

Meanwhile, if as a result of the judgment in the step S16A, the average hand tremor amount M0 is smaller than the threshold value L2A or the hand tremor tendency information 200 is not the hand tremor tendency β of skilled photographers (NO in the step S16A), since it is apparent from the judgment result of the steps S14A and S16A that the hand tremor tendency information 200 represents the hand tremor tendency α, the control section 60 subsequently judges whether or not the average hand tremor amount M0 is no greater than the threshold value L2A and the hand tremor tendency information 200 represents the hand tremor tendency α of unskilled photographers (step S17A).

If the average hand tremor amount M0 is no greater than the threshold value L2A and the hand tremor tendency information 200 represents the hand tremor tendency α of unskilled photographers (YES in the step S17A), in other words, in the case in which the average hand tremor amount M0 right before operation of the shutter button represents the hand tremor tendency β of skilled photographers while the hand tremor tendency information 200 represents the hand tremor tendency α of unskilled photographers, the control section 60 executes the shooting process for unskilled photographers described later (step S18A) in order to give priority to the hand tremor tendency represented by the hand tremor tendency information 200.

Meanwhile, if the average hand tremor amount M0 is greater than the threshold value L2A or the hand tremor tendency information 200 is not the hand tremor tendency α of unskilled photographers (NO in the step S17A), since according to the judgment results of the step Sb4 and Sb6, the average hand tremor amount M0 is no smaller than the threshold value L2A and the hand tremor tendency information 200 represents the hand tremor tendency α of unskilled photographers, and accordingly, both of the average hand tremor amount M0 right before operation of the shutter button and the hand tremor tendency information 200 represent the hand tremor tendency α of unskilled photographers, the shooting process for unskilled photographers shown in the step S18A is executed.

According to the above processes, the hand tremor tendency is specified based on the hand tremor tendency information 200 of the photographer previously stored in the ROM 62 irrespective of the hand tremor amount Q right before operation of the shutter button, and the shooting process in accordance with the hand tremor tendency is executed, even in the case in which a skilled photographer accidentally produces large amount of hand tremor before the holding-down operation of the shutter button 41a because of a bad health condition or by performing shooting with an unstable posture, or on the contrary, in the case in which an unskilled photographer accidentally produces a small amount of hand tremor before the holding-down operation of the shutter button 41a, a shooting process suitable for the actual photographer is executed.

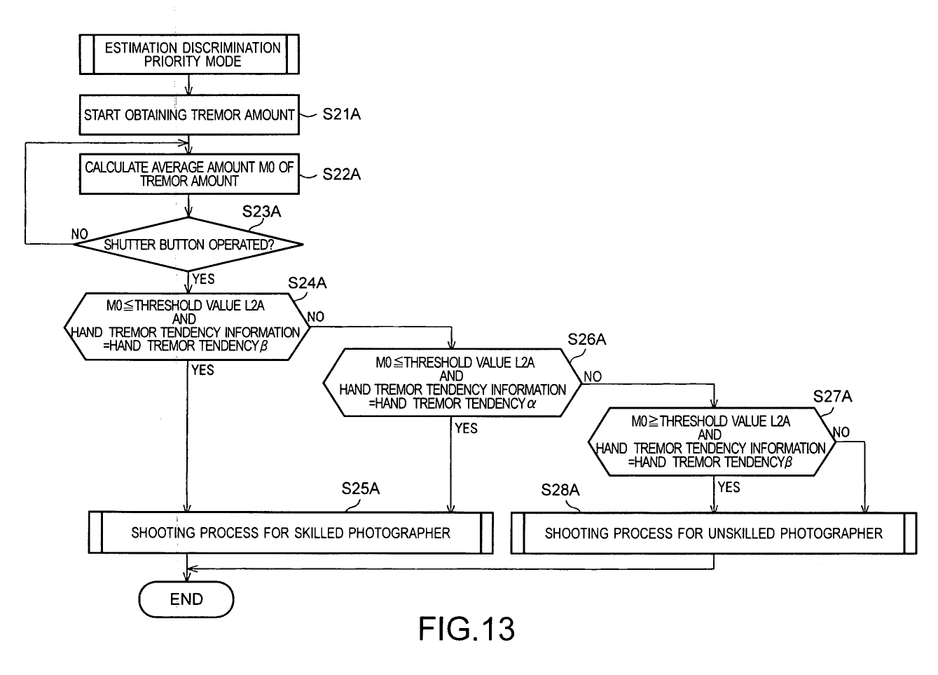

FIG. 13 is a flowchart showing the operation in the estimation discrimination priority mode. As shown in this drawing, when the estimation discrimination priority mode is selected, similarly to the operation in the hand tremor tendency priority mode, the control section 60 firstly starts acquiring the hand tremor amount Q to sequentially store in the RAM 63 (step S21A), obtains the average hand tremor amount MO by calculation every elapse of a constant period of time (step S22A), and subsequently judges whether or not the shutter button 41a is fully held down (step S23A). If the shutter button 41a has not been fully held down (NO in the step S23A), the control section 60 repeats performing the process in the step S22A until the full-holding-down operation of the shutter button 41a is performed, thus updating the average hand tremor amount M0 to the latest value.

On the other hand, if the full-holding-down operation of the shutter button 41a is performed (YES in the step S23A), the control section 60 judges whether or not the average hand tremor amount M0 is no greater than the threshold value L2A and the hand tremor tendency information 200 stored in the ROM 62 represents the hand tremor tendency β of skilled photographers (step S24A). If the average hand tremor amount MO is no greater than the threshold value L2A and the hand tremor tendency information 200 represents the hand tremor tendency β of skilled photographers (YES in the step S24A), the control section 60 performs the shooting process for skilled photographers described later (step S25A) since both of the average hand tremor amount M0 right before operation of the shutter button and the hand tremor tendency information 200 represent the hand tremor tendency β of skilled photographers.

On the other hand, if the average hand tremor amount M0 is greater than the threshold value L2A or the hand tremor tendency information 200 is not the hand tremor tendency β of skilled photographers (NO in the step S24A), the control section 60 judges whether or not the average hand tremor amount M0 is no greater than the threshold value L2A and the hand tremor tendency information 200 represents the hand tremor tendency α of unskilled photographers (step S26A). Further, if the average hand tremor amount M0 is no greater than the threshold value L2A and the hand tremor tendency information 200 represents the hand tremor tendency α of unskilled photographers (YES in the step S26A), in other words, the average hand tremor amount M0 right before operation of the shutter button suggests the hand tremor tendency β of skilled photographers while the hand tremor tendency information 200 represents the hand tremor tendency α of skilled photographers, the control section 60 moves the process procedure to the step S25A described above to execute the shooting process for skilled photographers in order to give priority to the hand tremor tendency represented by the average hand tremor amount M0 right before operation of the shutter button.

Meanwhile, as a result of the judgment in the step S26A, if the average hand tremor amount M0 is greater than the threshold value L2A or the hand tremor tendency information 200 is not the hand tremor tendency α of unskilled photographers (NO in the step S26A), it becomes apparent that the average hand tremor amount M0 is no smaller than the threshold value L2A considering the judgment result in the step S24A. Therefore, the control section 60 then judges whether or not the average hand tremor amount M0 is no less than the threshold value L2A and the hand tremor tendency information 200 represents the hand tremor tendency β of skilled photographers (step S27A).

If the average hand tremor amount M0 is no smaller than the threshold value L2A and the hand tremor tendency information 200 represents the hand tremor tendency β of skilled photographers (YES in the step S27A), in other words, in the case in which the average hand tremor amount M0 right before operation of the shutter button represents the hand tremor tendency α of unskilled photographers while the hand tremor tendency information 200 represents the hand tremor tendency β of skilled photographers, the control section 60 executes the shooting process for unskilled photographers described later (step S28A) in order to give priority to the hand tremor tendency represented by the average hand tremor amount M0 right before operation of the shutter button.

Meanwhile, if the average hand tremor amount M0 is smaller than the threshold value L2A or the hand tremor tendency information 200 is not the hand tremor tendency β of skilled photographers (NO in the step S27A), since according to the judgment results of the step S24A and S26A, the average hand tremor amount M0 is no smaller than the threshold value L2A and the hand tremor tendency information 200 represents the hand tremor tendency α of unskilled photographers, and accordingly, both of the average hand tremor amount M0 right before operation of the shutter button and the hand tremor tendency information 200 represent the hand tremor tendency α of unskilled photographers, the control section 60 performs the shooting process for unskilled photographers shown in the step S28A.

According to the above processes, since in the estimation discrimination priority mode, the hand tremor tendency is judged based on the hand tremor amount Q right before operation of shutter button irrespective of the hand tremor tendency information 200, even in the case in which the owner of the digital camera 10 lends the digital camera 10 to another person, an appropriate shooting process is performed in accordance with the hand tremor tendency in actual shooting operation.

Subsequently, the shooting process for skilled photographers and the shooting process for unskilled photographers described above will be described in detail. In the shooting process for skilled photographers, the process for commencing shooting after the hand tremor amount Q has become sufficiently small is performed after the holding-down operation of the shutter button 41a, while in the shooting process for unskilled photographers, the shooting is performed in the condition with which the jitter is hardly caused in the shot image.

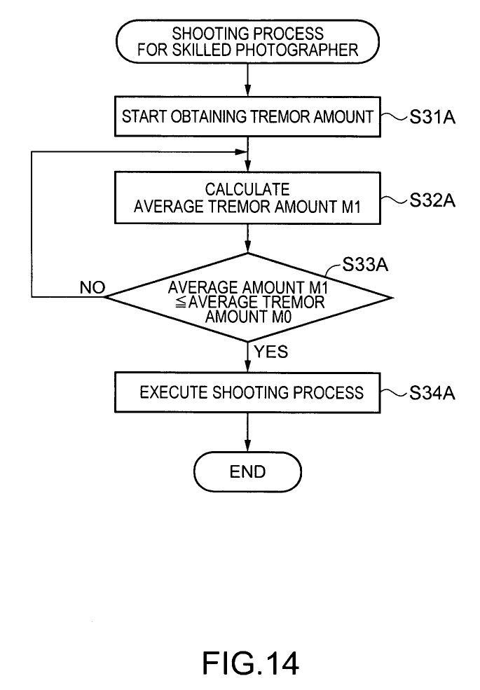

Specifically, as shown in FIG. 14, in the shooting process for skilled photographers, before all the control section 60 sequentially obtains the hand tremor amount Q after operation of the shutter button (step S31A), then obtains the average value (hereinafter referred to as an average hand tremor amount M1) of these hand tremor amounts Q by calculation (step S32A), and judges whether or not the average hand tremor amount M1 is equal to or smaller than the average hand tremor amount M0 before operation of the shutter button which is pre-stored (step S33A).

In this case, if the average hand tremor amount M1 is larger than the average hand tremor amount M0 (NO in the step S33A), the control section 60 moves to the process in the step S32A, thus newly obtaining the average hand tremor amount M1, and judges again whether or not this average hand tremor amount M1 is no larger than the average hand tremor amount M0.

Meanwhile, if the average hand tremor amount M1 is no greater than the average hand tremor amount M0 before operation of the shutter button (YES in the step S33A), since it is estimated that the tremor caused by the operation of the shutter button has converged, the control section 60 performs shooting with the shooting conditions (exposure time, aperture value, and sensitivity) automatically set by the control section 60 or manually set by the user (step S34A). Thus, shooting can be performed with the timing when the hand tremor amount Q has become sufficiently small in the equivalent shooting conditions to those of the normal mode set by the user or by the control section 60, thereby a less jittery and high quality image can be shot while performing shooting in the shooting conditions as set by the photographer.

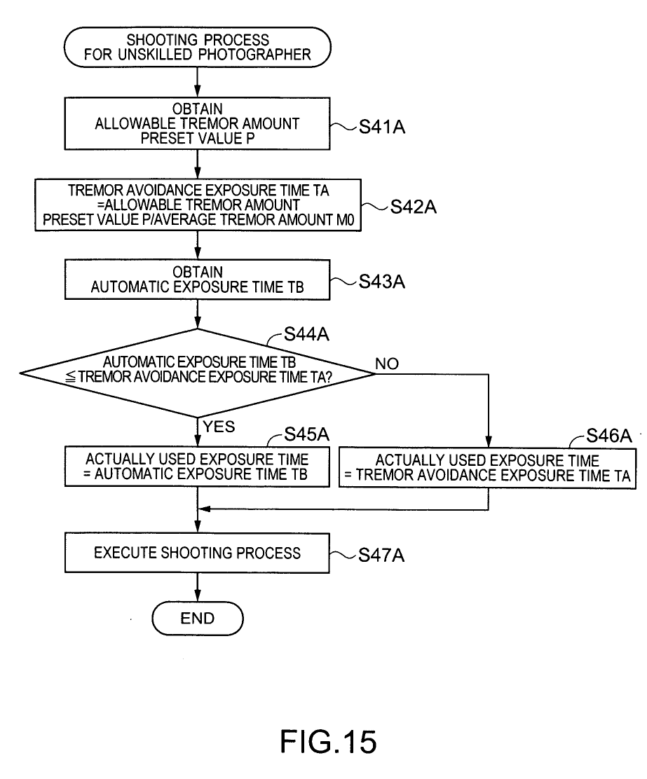

In the shooting process for unskilled photographers, as shown in FIG. 15, the control section 60 firstly obtains an allowable jitter amount preset value P, which is previously described in the shooting program (step S41A). This allowable jitter amount preset value P is a value for indicating an amount of jitter that is so small as to be not conspicuous if caused in a shot image. Subsequently, the control section 60 divides the allowable jitter amount preset value P by the stored average hand tremor amount M0, and sets the jitter avoidance exposure time TA, with which jitter can be avoided, based on the division value (step S42A).

Subsequently, the control section 60 obtains the exposure time (hereinafter referred to as an automatic exposure time) TB for the case in which the automatic exposure is performed in accordance with shooting conditions pre-set by the photographer (step S43A), and judges whether or not the automatic exposure time TB is no greater than the jitter avoidance exposure time TA (step S44A).

If the automatic exposure time TB is no greater than the jitter avoidance exposure time TA (YES in the step S44A), a sufficiently less jittery shot image can be obtained even with the shooting conditions set by the photographer, and accordingly, the control section 60 sets the automatic exposure time TB as the actually used exposure time (step S45A). Meanwhile, if the automatic exposure time TA exceeds the jitter avoidance exposure time TB (NO in the step S44A), a shot image with no jitter is not obtained with the shooting conditions set by the photographer, and therefore, the jitter avoidance exposure time TA calculated in the step S32A is set as the actually used exposure time (step S46A). Thereafter, the control section 60 performs shooting with the exposure time set in the step S45A or S46A described above (step S47A).

According to the above processes, since the shooting is performed with the modified shooting conditions allowing jitter avoidance only in the case in which a shot image with no jitter is not obtained with the shooting conditions set by the photographer, the shooting is performed along the intention of the photographer as long as no jitter is caused, and if jitter is caused, the shooting conditions are changed to make it possible to obtain a shot image with no (or not conspicuous) jitter even under circumstances with relatively large amount of tremor.

As explained above, the present embodiment is provided with the hand tremor tendency priority mode in which the hand tremor tendency information 200 stored previously is given priority over the result of the estimation discrimination of the hand tremor tendency performed every shooting operation based on the hand tremor amount Q before the operation of the shutter button 41a to perform the shooting process in accordance with the hand tremor tendency represented by the hand tremor tendency information 200, and the estimation discrimination priority mode in which the result of the estimation discrimination of the hand tremor tendency described above is given priority over the hand tremor tendency information 200 to perform the shooting operation in accordance with the hand tremor tendency represented by the result of the estimation discrimination, and configured so as to be able to select them.

Therefore, according to the present embodiment, the hand tremor tendency of the photographer can simply be specified based on the hand tremor amount Q, and further, an appropriate shooting process can be performed in accordance with the hand tremor tendency, thus a less jittery shot image can be obtained.

In particular, according to the present embodiment, since it is arranged that the hand tremor tendency information 200 is pre-stored, and which one of the hand tremor tendency information 200 and the estimation discrimination result of the hand tremor tendency is given priority can be selectively determined, in the case in which unusual hand tremor different from the usual hand tremor may be caused because of, for example, a poor standing point when shooting or a bad health condition, the photographer can select the hand tremor tendency priority mode to perform suitable shooting operation in accordance with the hand tremor tendency represented by the hand tremor tendency information 200, namely usual hand tremor tendency of the photographer irrespective of the result of estimation discrimination of the hand tremor tendency performed every shooting operation.

Further, if the photographer is temporarily switched by lending the digital camera to another person, the photographer at that time can select the estimation discrimination priority mode to perform a suitable shooting process in accordance with the hand tremor tendency estimated by the result of the estimation discrimination of the hand tremor tendency performed every shooting operation irrespective of the hand tremor tendency information 200 stored previously.

As described above, according to the present embodiment, even in the case in which the conditions of the photographer have changed or the case in which the photographer has temporarily been switched to another photographer, the shooting process corresponding to the original hand tremor tendency of the present photographer can be executed.

Further, according to the present embodiment, there is provided a configuration of comparing the hand tremor amounts Q before and after operation of the shutter button 41a, specifying the hand tremor tendency of the photographer, previously generating the hand tremor tendency information 200 described above, and storing it in the ROM 62. According to this configuration, since the hand tremor tendency of the photographer is specified by comparing the hand tremor amounts Q before and after the shutter button 41a is operated, the hand tremor tendency can be precisely specified. Further, since the hand tremor tendency thus specified is stored previously in the ROM 62 as the hand tremor tendency information 200, there is no need for detecting the hand tremor amount Q after operation of the shutter button 41a in the actual shooting operations, thus shooting operations can quickly be completed.

Still further, according to the present embodiment, since the hand tremor tendencies are categorized into at least two: one is the hand tremor tendency β of skilled photographers that the hand tremor of the photographer converges on the hand tremor amount Q so small as to cause no conspicuous jitter on the shot image after the holding-down operation of the shutter button 41a; the other is the hand tremor tendency α of unskilled photographers that the hand tremor of the photographer does not converge on the hand tremor amount Q so small as to cause no conspicuous jitter on the shot image after the holding-down operation of the shutter button 41a, it is possible to specify whether or not the hand tremor of the photographer becomes smaller after the holding-down operation of the shutter button 41a. Thus, whether or not the shooting with no jitter is possible can easily be specified only by providing an interval after the holding-down operation of the shutter button 41a.

Further, according to the present embodiment, if the hand tremor tendency of the photographer is the hand tremor tendency β of skilled photographer, the shooting operation commences when the hand tremor amount Q has converged after the holding-down operation of the shutter button 41a, and accordingly, the shooting operation can be performed with the timing immediately after the hand tremor has converged, thus making it possible to shoot a less jittery image while suppressing the time lag.

Still further, according to the present embodiment, if the hand tremor tendency of the photographer is the hand tremor tendency α of unskilled photographers, the shooting operation is commenced with shooting conditions including exposure time, aperture value, and sensitivity changed to those hardly causing jitter on the shot image, and accordingly, the shooting can immediately be performed with the shooting conditions hardly causing jitter thereon, thus making it possible to shoot a less jittery image without a time lag.

It should be noted that in the present embodiment, the hand tremor tendency priority mode and the estimation discrimination priority mode can be selected. In this case, since in the hand tremor tendency priority mode, the hand tremor tendency of the hand tremor tendency information 200 is given priority regardless of the estimation discrimination result based on the hand tremor amount Q before the holding-down operation of the shutter button 41a, in the hand tremor priority mode, the hand tremor tendency can be specified with reference to the hand tremor tendency information 200 without detecting the hand tremor amount Q.

Further, since in the estimation discrimination priority mode, the estimation discrimination result based on the hand tremor amount Q prior to the holding-down operation of the shutter button 41a is given priority irrespective of the hand tremor tendency of the hand tremor tendency information 200, in the estimation discrimination priority mode, it is possible to perform only estimation discrimination based on the hand tremor amount Q prior to the holding-down operation of the shutter button 41a without referring to the hand tremor tendency information 200.

### Fifth Embodiment

The digital camera 10 according to a fifth embodiment is substantially the same as the digital camera 10 according to the first embodiment except the point that the digital camera 10 according to the fifth embodiment specifies the hand tremor tendency based on the hand tremor amounts Q before and after a semi-holding-down operation of the shutter button 41a and performs shooting in accordance with the hand tremor tendency.

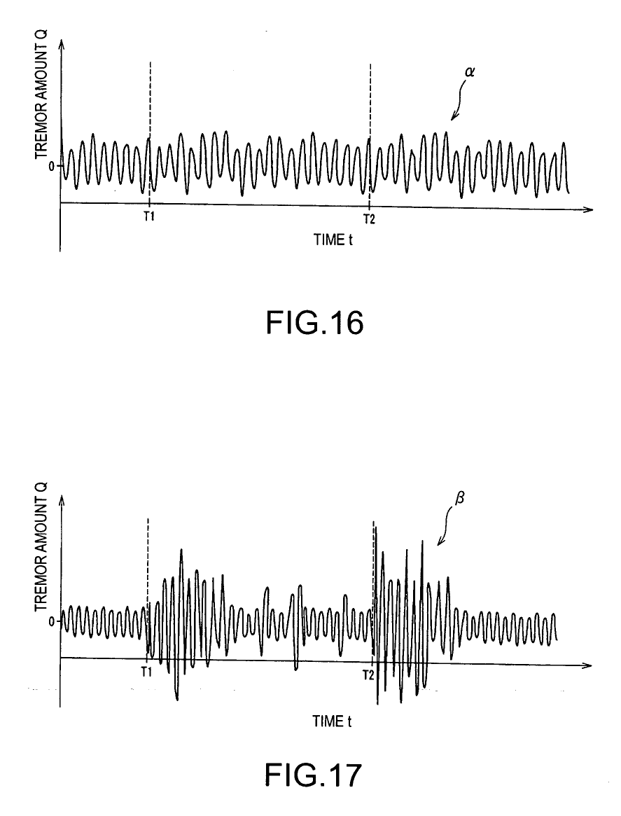

FIG. 16 is a diagram showing the hand tremor tendency α of unskilled photographers, and FIG. 17 is a diagram showing the hand tremor tendency β of skilled photographers. Further, in these drawings, time T1 denotes the timing when the shutter button 41a is halfway held down, and time T2 denotes the timing when the shutter button 41a is fully held down.

From the comparison therebetween, it is found that in the case with unskilled photographers, as shown in FIG. 16, there is a hand tremor tendency α that the hand tremor amount Q hardly varies before and after both of the timing T1 of halfway holding-down the shutter button 41a and the timing T2 of fully holding-down it while in the case with skilled photographers, as shown in FIG. 17, there is a hand tremor tendency β that the hand tremor amount Q increases right after the timing T1 of halfway holding-down the shutter button 41a and the timing T2 of fully holding-down it, but is kept smaller than the hand tremor amount Q of unskilled photographers in any other timing. In other words, it has been found that the hand tremor amount Q of the unskilled photographers hardly varies before and after the operation of the shutter button 41a while the hand tremor amount Q of the skilled photographers significantly varies before and after the operation of the shutter button 41a, and converges after the full-holding-down operation of the shutter button 41a.

Therefore, in the present embodiment, the control program 100 includes a photographer discrimination program for executing the photographer discrimination process for judging which one of two hand tremor tendencies α and β the hand tremor tendency corresponds to based on the hand tremor amounts Q before and after the semi-holding-down operation of the shutter button 41a, and discriminating whether the photographer is a skilled photographer or a unskilled photographer.

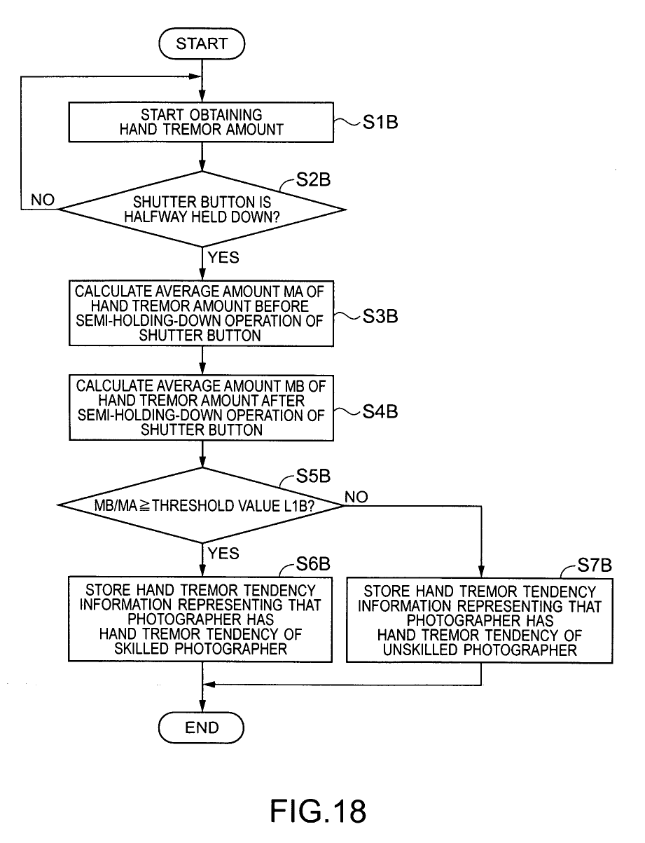

The operation when executing the photographer discrimination program will now be explained. FIG. 18 is a flowchart showing the operation in the present case. This shooting program is executed in the shooting mode, and firstly, when moving to the shooting mode, the control section 60 performs a tremor amount obtaining process (step S1B). This tremor amount obtaining process is a process in which the control section 60 acquires the angular velocity detection signal from the angular velocity detection section 50, calculates the tremor amount Q, and obtains the hand tremor amount Q in each of a plurality of time points by repeatedly performing the calculation process a number of times to store them in the RAM 63.

Subsequently, the control section 60 judges whether or not the shutter button 41a is halfway held down (step S2B), if it is not halfway held down (NO in the step S2B), the control section 60 updates the hand tremor amount Q stored in the RAM 63 with the latest value until the semi-holding-down operation is performed, and stores a last predetermined number of samples of the hand tremor amount Q in the RAM 63.

On the other hand, if the semi-holding-down operation of the shutter button 41a is performed (YES in the step S2B), the control section 60 obtains the average value (the average hand tremor amount) MA of the number of samples of hand tremor amount Q before the semi-holding-down stored in the RAM 63 by calculation (step S3B), at the same time continues the hand tremor amount obtaining process to obtain the hand tremor amounts Q at a number of time points (a number of samples) after the semi-holding-down operation, thus obtaining the average value (the average hand tremor amount) MB of the hand tremor amounts Q after the semi-holding-down operation by calculation (step S4B).

Subsequently, the control section 60 obtains the value X obtained by dividing the average hand tremor amount MB after the semi-holding-down operation by the average hand tremor amount MA before the semi-holding-down operation, and judges whether or not the division value X is no smaller than a predetermined threshold value L1B (step S5B). It should be noted here that the threshold value L1B is a criterion measure for judging whether the hand tremor amount Q before and after the semi-holding-down operation of the shutter button 41a corresponds to skilled photographers or unskilled photographers, and for example, since the skilled photographers have an increase in the hand tremor amount Q immediately after the semi-holding-down operation, the division value X described above is a value no less than 1, while the unskilled photographers hardly vary in the hand tremor amount Q before and after the semi-holding-down operation, and accordingly, the division value X is expected to be a value around 1, and as the threshold value L1B, a value of, for example, 1.5 or larger can be adopted.

Further, if the division value X of the average hand tremor amount MB and the average hand tremor amount MA described above is equal to or greater than the threshold value L1B (YES in the step S5B), the control section 60 judges that the photographer is a skilled photographer, and stores hand tremor tendency information representing that the photographer has the hand tremor tendency of skilled photographers in the RAM 63 or the ROM 62 (step S6B), or if the division value X is smaller than the threshold value L1B (NO in the step S5B), it is judged that the photographer is an unskilled photographer, and the hand tremor tendency information representing that the photographer has the hand tremor tendency of unskilled photographers is stored in the RAM 63 or the ROM 62 (step S7B) The operation of the photographer discrimination process is as described hereinabove.

The photographer discrimination process is repeatedly executed in the shooting mode, thus the hand tremor tendency information of the photographer is stored and accumulated in the RAM 63 or the ROM 62 every time the photographer performs semi-holding-down of the shutter button 41a.

Subsequently, if the shutter button 41a is fully held down, the control section 60 refers to the accumulated hand tremor tendency information of the photographer, and if it is judged from the information that the photographer is a skilled photographer, the control section 60 performs the first shooting process in accordance with the hand tremor tendency β of skilled photographers, or if it is judged that the photographer is an unskilled photographer, the control section 60 performs the second shooting process in accordance with the hand tremor tendency α of unskilled photographers. The first shooting process and the second shooting process will hereinafter be described in detail.

In the case with the first shooting process, since there is a high possibility that the hand tremor tendency of the photographer becomes a tendency in which the hand tremor amount Q converges after the full-holding-down operation of the shutter button 41a (which corresponds to the hand tremor tendency β shown in FIG. 17), shooting is performed after delaying for the convergence of the hand tremor amount Q.

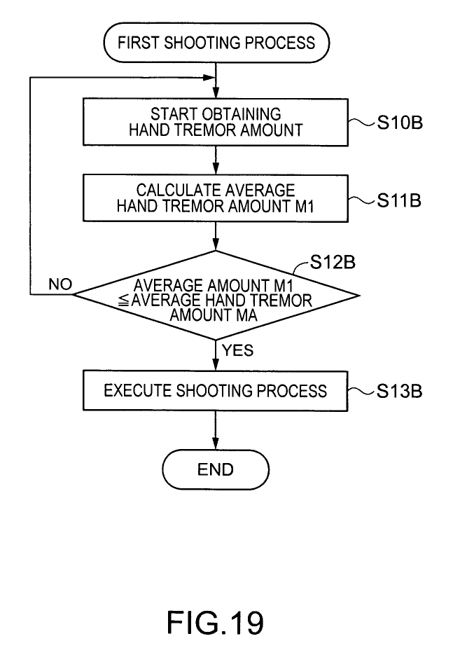

FIG. 19 is a flowchart showing the first shooting process. As shown in the drawing, the control section 60 firstly commences the tremor amount obtaining process to sequentially obtain the hand tremor amount Q after operation of the shutter button (step SLOB), then obtains the average value (hereinafter referred to as an average hand tremor amount M1) of these hand tremor amounts Q by calculation (step S11B), and judges whether or not the average hand tremor amount M1 is equal to or smaller than the average hand tremor amount MA before operation of the shutter button which is pre-stored (step S12B).

In this case, if the average hand tremor amount M1 is larger than the average hand tremor amount MA (NO in the step S12B), the control section 60 moves to the process in the step S10, thus newly obtaining the average hand tremor amount M1, and repeatedly performs the processes in the steps S10B through S12B for judging whether or not this average hand tremor amount M1 is no larger than the average hand tremor amount MA.

In this case, since there is a high possibility that the hand tremor tendency of the photographer becomes a tendency (the hand tremor tendency of skilled photographers) of converging after operation of the shutter button, the average hand tremor amount M1 converges on a value no greater than the average hand tremor amount MA prior to operating the shutter button (YES in the step S12B), and in this case, the control section 60 performs shooting (step S13B) with shooting conditions (the exposure time and the aperture value) automatically set by the control section 60 or manually set by the user. Thus, shooting can be performed with the most suitable conditions with the timing with which the hand tremor amount Q becomes the minimum, thereby a high quality image with less jitter can be shot. The first shooting process is as described hereinabove.

Then, the second shooting process will hereinafter be explained. In the case with the second shooting process, since there is a high possibility that the hand tremor tendency of the photographer becomes a non-converging tendency (which corresponds to the hand tremor tendency α shown in FIG. 16), it is arranged to obtain shooting conditions capable of reducing the effect of the jitter obtained from the hand tremor amount Q, and to perform shooting with severer conditions out of the present conditions and the conditions set automatically.

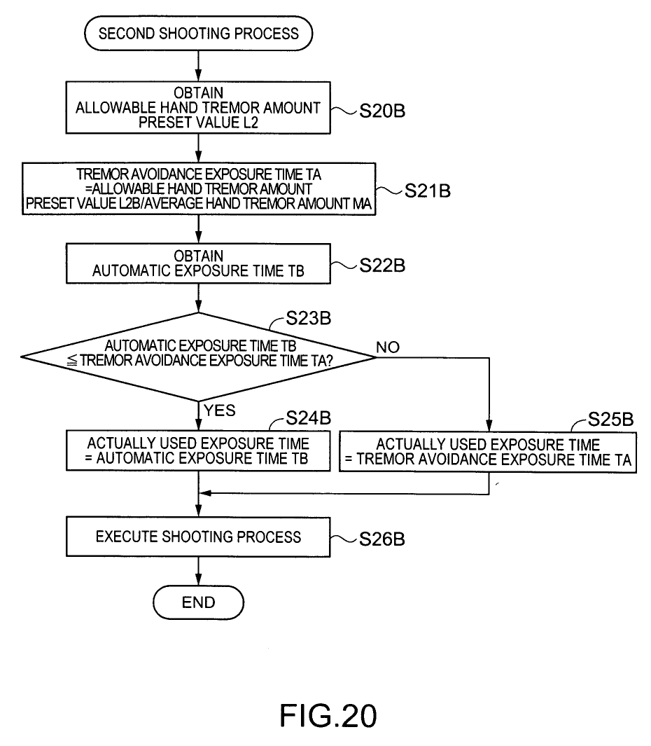

FIG. 20 is a flowchart showing the second shooting process. It should be noted that although the case in which the exposure time out of the shooting conditions is set is exemplified in the present embodiment, the exposure time is not the limitation, but the aperture value can be set.

As shown in FIG. 20, the control section 60 firstly obtains an allowable hand tremor amount preset value L2 previously described in the shooting program (step S20B), then divides the allowable hand tremor amount preset value L2B by the stored average hand tremor amount MA, and sets jitter avoidance exposure time TA allowing avoidance of the jitter in accordance with the division value (step S21B).

Subsequently, the control section 60 obtains the exposure time (hereinafter referred to as an automatic exposure time) TB used when performing the automatic exposure (step S22B), and judges whether or not the automatic exposure time TB is no greater than the jitter avoidance exposure time TA (step S23B). Further, if the automatic exposure time TB is no greater than the jitter avoidance exposure time TA (YES in the step S23B), the control section 60 sets the exposure time, which is to be actually used, to the automatic exposure time TB (step S24B), or if the automatic exposure time TA exceeds the jitter avoidance exposure time TB (No in the step S23B), the actually used exposure time is set to the automatic exposure time TA. Thereafter, the control section 60 performs shooting with the shooting conditions including the exposure time thus set as described above (step S25B).

As described above, since the shooting is performed with the exposure time no greater than the jitter avoidance exposure time TA allowing jitter avoidance, a less jittery image can be shot even under the condition with relatively large tremor amount, and further, since the shooting is performed immediately after operation of the shutter button, a delay in the shooting timing (a time lag) can be reliably avoided. The second shooting process is as described hereinabove.

As described above, since in the present embodiment whether the hand tremor tendency of the photographer is the tendency (the converging tendency) β of skilled photographers or the tendency (the non-converging tendency) α of unskilled photographers is specified based on the hand tremor amounts Q before and after the semi-holding down operation of the shutter button 41a, the hand tremor tendency of the photographer can be simply and quickly specified without performing a forecasting calculation or the like for forecasting the hand tremor tendency.

Furthermore, since in general, the semi-holding-down operation of the shutter button 41a is performed more frequently than the full-holding-down operation of the shutter button 41a, the number of sampling of the hand tremor tendency information can be increased compared to the case in which the hand tremor tendency information of the photographer is obtained from the hand tremor before and after the full-holding-down operation. Therefore, by judging whether the hand tremor tendency of the photographer is that of skilled photographer or that of unskilled photographer based on the hand tremor tendency information sampled many times, the accuracy of judgment is improved, and the optimum shooting process for shooting an image with no jitter can be selected from the first shooting process and the second shooting process.

Specifically, in the case of judging the hand tremor tendency of the photographer, it is possible to apply a method of simply adopting the most frequent hand tremor tendency information out of the hand tremor tendency information sampled many times, a method of adopting the most frequent hand tremor tendency information out of the latest (the latest period of time or the latest few samples of) hand tremor tendency information, or a method of providing the heavier density to the later information and adopting the hand tremor tendency information with the highest density. By adopting the method described above, even in the case, for example, the photographer, who is actually a beginner photographer (an unskilled photographer), accidentally shows the same hand tremor tendency as skilled photographers, it becomes possible to avoid misjudging the photographer as a skilled photographer.

Further, since in the case in which the hand tremor tendency of the photographer is the tendency β of skilled photographers, the shooting is performed immediately with the timing with which the hand tremor tendency has converged in the present embodiment, it becomes possible to shoot a less jittery image with proper shooting conditions while controlling the time lag. Further, since in the case in which the hand tremor tendency of the photographer is the tendency α of unskilled photographers, the shooting is immediately performed with the shooting conditions allowing avoidance of the jitter, it becomes possible to shoot a less jittery image without a time lag.

It should be noted that, although the case in which the hand tremor amounts Q before and after the semi-holding-down operation of the shutter button 41a are obtained, and whether the hand tremor tendency of the photographer is the hand tremor tendency α of unskilled photographers or the hand tremor tendency β of skilled photographers is judged based on the ratio of the hand tremor amounts is described in the present embodiment, this is not a limitation.

For example, focusing on the fact that skilled photographers have smaller hand tremor amount Q before the semi-holding-down operation of the shutter button 41a compared to unskilled photographers, it is possible to judge the hand tremor tendency of the photographer based only on the average hand tremor amount MA before the semi-holding-down operation of the shutter button 41a.

Further, besides the above, focusing on the fact that skilled photographers instantaneously have greater hand tremor amount Q after the semi-holding-down operation of the shutter button 41a compared to the amount before the semi-holding-down operation, it is possible to obtain the average hand tremor amount MA before the semi-holding-down operation of the shutter button 41a and the maximum hand tremor amount Mmax after the semi-holding-down operation, and to judge the hand tremor tendency of the photographer based on the ratio of the maximum amount Mmax and the average hand tremor amount MA.

Further, focusing on the fact that the hand tremor amount Q after the semi-holding-down operation of the shutter button 41a of skilled photographers is scattered in comparison with the case with unskilled photographers, it is possible to obtain the fluctuation (dispersion) of the hand tremor amount Q after the semi-holding-down by calculation, and judge the hand tremor tendency of the photographer based on this value.

### Sixth Embodiment

The digital camera 10 according to a sixth embodiment is substantially the same as the digital camera 10 according to the first embodiment except the point that the digital camera 10 according to the sixth embodiment performs frequency analysis of the tremor of the photographer to specify the hand tremor tendency, thereby performing shooting in accordance with the hand tremor tendency.

As described above, it is found that in the case with unskilled photographers, as shown in FIG. 16, there is a hand tremor tendency α that the hand tremor amount Q hardly varies before and after both of the timing T1 of halfway holding-down the shutter button 41a and the timing T2 of fully holding-down it while in the case with skilled photographers, as shown in FIG. 17, there is a hand tremor tendency β that the hand tremor amount Q increases right after the timing T1 of halfway holding-down the shutter button 41a and the timing T2 of fully holding-down it, but is kept smaller than the hand tremor amount Q of unskilled photographers in any other timing. In other words, it has been found that the hand tremor amount Q of the unskilled photographers hardly varies before and after the operation of the shutter button 41a while the hand tremor amount Q of the skilled photographers significantly varies before and after the operation of the shutter button 41a, and converges after the full-holding-down operation of the shutter button 41a.

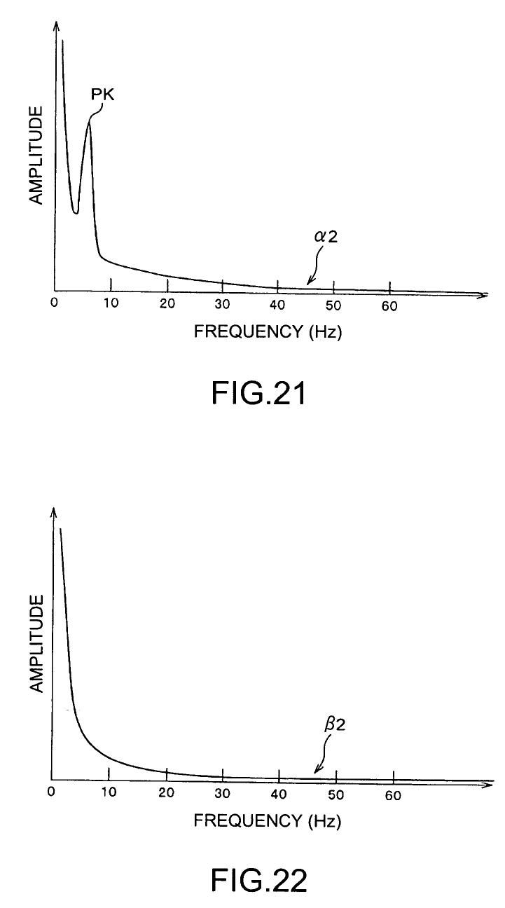

FIG. 21 is a diagram showing the frequency characteristic of the hand tremor (the hand tremor tendency α2) of unskilled photographers, and FIG. 22 is a diagram showing the frequency characteristic of the hand tremor (the hand tremor tendency β2) of skilled photographers.

Further, when the inventors analyzed the frequency of the hand tremor, it was found that in the case with skilled photographers, as shown in FIG. 22, the hand tremor tendency β2 does not include constant deviation in the amplitude of the tremor, while in the case with unskilled photographers, as shown in FIG. 21, the hand tremor tendency α2 includes a part PK constantly around 10 Hz having a large amplitude.

Accordingly, in the present embodiment, the control program 100 includes a photographer discrimination program for performing a photographer discrimination process for performing the frequency analysis of the tremor to judge whether or not the amplitude deviation of the tremor constantly around 10 Hz, namely “unskilled photographer specific tremor” exists, thereby discriminating whether the photographer is a skilled photographer or an unskilled photographer.

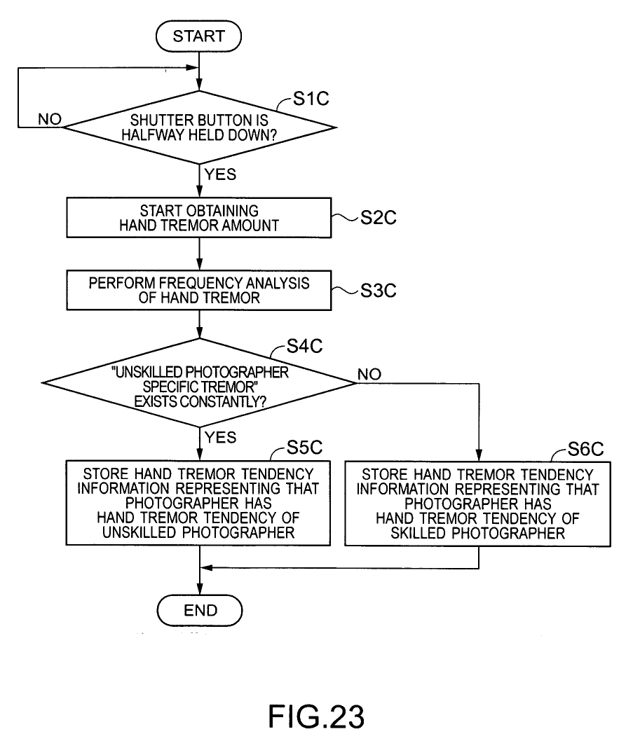

The operation when executing the photographer discrimination program will now be explained. FIG. 23 is a flowchart showing the operation in the present case. The shooting program is executed in the shooting mode, and firstly, the control section 60, when moving to the shooting mode, judges whether or not the shutter button 41a is halfway held down (step S1C), and waits until the shutter button 41a is halfway held down (NO in the step S1C).

Then, if the shutter button 41a is halfway held down (YES in the step S2C), the control section 60 commences the tremor obtaining process (step S2C). This tremor obtaining process is a process in which the control section 60 obtains the angular velocity detection signal from the angular velocity detection section 50, stores the signal in the RAM 63 as tremor waveform data corresponding to the hand tremor, and calculates the hand tremor amount Q, obtains the hand tremor amounts Q at a number of time points by repeatedly performing the calculation process to obtain the average value (the average hand tremor amount) MA of the hand tremor amounts Q by calculation, and stores it in the RAM 63.

After completing the tremor obtaining process, to perform frequency analysis of the tremor waveform data stored in the RAM 63, the control section 60 performs a Fourier transformation (e.g., fast Fourier transformation) process on the tremor waveform data to extract how much of what frequency components are included in the tremor waveform data (step S3C). Further, the control section 60 judges whether or not “the unskilled photographer specific tremor,” specifically, a constant tremor with a greater amplitude than a predetermined amplitude in a predetermined frequency range SH exists (step S4C).

More specifically, in the process of the step S4C, the control section 60 divides the tremor waveform data by a predetermined time unit, performs the Fourier transformation for every divisional tremor waveform data to judge whether or not there is a tremor with greater amplitude than the predetermined amplitude within the frequency range SH for every divisional data, and based on the probability of existence, whether or not “the unskilled photographer specific tremor” constantly exists is judged. It should be noted that it is sufficient for the frequency range SH to be within the range of 4 through 19 Hz which is the maximum frequency range in which “the unskilled photographer specific tremor” exists, and from the view point of judgment accuracy enhancement, the frequency range of 5 through 10 Hz with higher probability of the existence of “the unskilled photographer specific tremor” is preferable.

It should be noted that instead of the above described method of dividing the tremor waveform data and judging whether or not “the unskilled photographer specific tremor” exists in each of the divisional data, whether or not “the unskilled photographer specific tremor” exists can also be judged by obtaining a number of pieces of the tremor waveform data with shifted timings to be stored in the RAM 63, and judging whether or not “the unskilled photographer specific tremor” exists for every piece of data.

Then, if the control section 60 has judged that “the unskilled photographer specific tremor” constantly exists in the judgment in the step S4C (YES in the step S4C), the control section 60 judges that the photographer is an unskilled photographer, and the hand tremor tendency information representing that the photographer has the hand tremor tendency of skilled photographer is stored in the RAM 63 or the ROM 62 (step S5C).

Meanwhile, if it has judged that “the unskilled photographer specific tremor” does not constantly exist in the judgment in the step S4C (NO in the step S4C), the control section 60 judges that the photographer is a skilled photographer, and the hand tremor tendency information representing that the photographer has the hand tremor tendency of skilled photographer is stored in the RAM 63 or the ROM 62 (step S7C). The operation of the photographer discrimination process is as described hereinabove.

The photographer discrimination process is repeatedly executed in the shooting mode, thus the hand tremor tendency information of the photographer is stored and accumulated in the RAM 63 or ROM 62 every time the photographer performs semi-holding-down of the shutter button 41a.

Subsequently, if the shutter button 41a is fully held down, the control section 60 refers to the accumulated hand tremor tendency information of the photographer, and if it is judged from the information that the photographer is a skilled photographer, the control section 60 performs the first shooting process in accordance with the hand tremor tendency β of skilled photographers, or if it is judged that the photographer is an unskilled photographer, the control section 60 performs the second shooting process in accordance with the hand tremor tendency α of unskilled photographers. The first shooting process and the second shooting process will hereinafter be described in detail.

In the case with the first shooting process, since there is a high possibility that the hand tremor tendency of the photographer becomes a tendency in which the hand tremor amount Q converges after the full-holding-down operation of the shutter button 41a (which corresponds to the hand tremor tendency β shown in FIG. 17), shooting is performed after delaying for the convergence of the hand tremor amount Q.

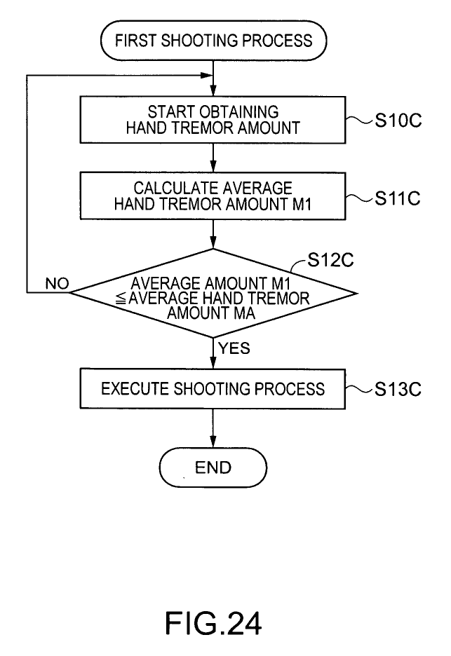

FIG. 24 is a flowchart showing the first shooting process. As shown in the drawing, the control section 60 firstly commences the tremor amount obtaining process to sequentially obtain the hand tremor amount Q after operation of the shutter button (step S10C), then obtains the average value (hereinafter referred to as an average hand tremor amount M1) of these hand tremor amounts Q by calculation (step S11C), and judges whether or not the average hand tremor amount M1 is equal to or smaller than the average hand tremor amount MA before operation of the shutter button which is pre-stored (step S12C).

In this case, if the average hand tremor amount M1 is larger than the average hand tremor amount MA (NO in the step S12C), the control section 60 moves to the process in the step S10C, thus newly obtaining the average hand tremor amount M1, and repeatedly performs the processes in the steps S10C through S12C for judging whether or not this average hand tremor amount M1 is no larger than the average hand tremor amount MA.

In this case, since there is a high possibility that the hand tremor tendency of the photographer becomes a tendency (the hand tremor tendency of skilled photographers) of converging after operation of the shutter button, the average hand tremor amount M1 converges on a value no greater than the average hand tremor amount MA prior to operating the shutter button (YES in the step S12C), and in this case, the control section 60 performs shooting (step S13C) with shooting conditions (the exposure time and the aperture value) automatically set by the control section 60 or manually set by the user. Thus, shooting can be performed with the most suitable conditions with the timing with which the hand tremor amount Q becomes the minimum, thereby a high quality image with less jitter can be shot. The first shooting process is as described hereinabove.

Then, the second shooting process will hereinafter be explained. In the case with the second shooting process, since there is a high possibility that the hand tremor tendency of the photographer becomes a non-converging tendency (which corresponds to the hand tremor tendency α shown in FIG. 16), it is arranged to obtain shooting conditions capable of reducing the effect of the jitter obtained from the hand tremor amount Q, and to perform shooting with severer conditions out of the present conditions and the conditions set automatically.

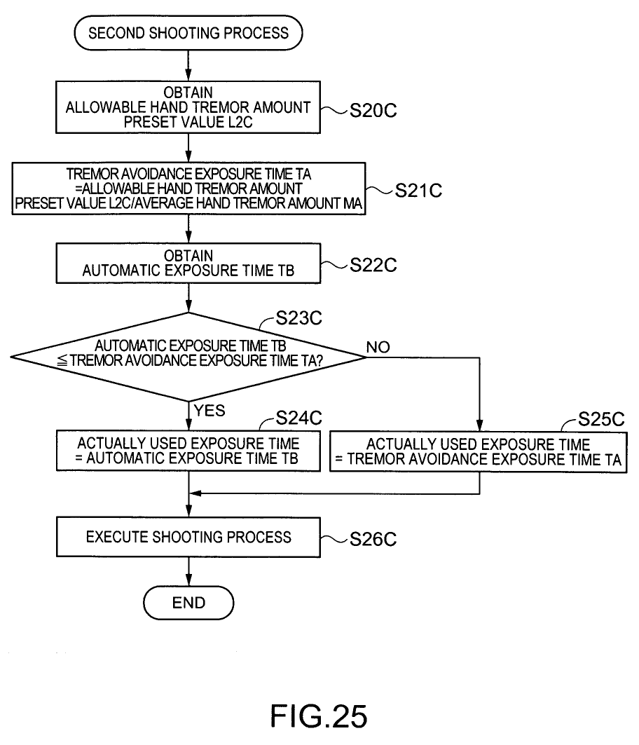

FIG. 25 is a flowchart showing the second shooting process. It should be noted that although the case in which the exposure time out of the shooting conditions is set is exemplified in the present embodiment, the exposure time is not the limitation, but the aperture value can be set.

As shown in FIG. 25, the control section 60 firstly obtains an allowable hand tremor amount preset value L2C previously described in the shooting program (step S20C), then divides the allowable hand tremor amount preset value L2C by the stored average hand tremor amount MA, and sets jitter avoidance exposure time TA allowing avoidance of the jitter in accordance with the division value (step S21C).

Subsequently, the control section 60 obtains the exposure time (hereinafter referred to as an automatic exposure time) TB used when performing the automatic exposure (step S22C), and judges whether or not the automatic exposure time TB is no greater than the jitter avoidance exposure time TA (step S23C). Further, if the automatic exposure time TB is no greater than the jitter avoidance exposure time TA (YES in the step S23C), the control section 60 sets the exposure time, which is to be actually used, to the automatic exposure time TB (step S24C), or if the automatic exposure time TA exceeds the jitter avoidance exposure time TB (No in the step S23C), the actually used exposure time is set to the automatic exposure time TA. Thereafter, the control section 60 performs shooting with the shooting conditions including the exposure time thus set as described above (step S25C).

As described above, since the shooting is performed with the exposure time no greater than the jitter avoidance exposure time TA allowing jitter avoidance, a less jittery image can be shot even under the condition with relatively large hand tremor amount Q, and further, since the shooting is performed immediately after operation of the shutter button, a delay in the shooting timing (a time lag) can reliably be avoided. The second shooting process is as described hereinabove.

As described above, since in the present embodiment, frequency analysis of the tremor after the semi-holding-down operation of the shutter button 41a is performed to judge whether or not “the unskilled photographer specific tremor” exists, and based on the judgment result, whether the hand tremor tendency of the photographer is the tendency (the converging tendency) β of skilled photographers or the tendency (the non-converging tendency) α of unskilled photographers is specified, the hand tremor tendency of the photographer can simply and quickly be specified without performing a forecasting calculation or the like for forecasting the hand tremor tendency.

Furthermore, in the present embodiment, since whether or not “the unskilled photographer specific tremor” exists constantly is judged, even if the photographer who is a skilled photographer accidentally causes the tremor similar to “the unskilled photographer specific tremor,” the frequency of occurrence is very low, and accordingly, the case in which the photographer is misjudged as an unskilled photographer can be avoided.

Further, since in general, the semi-holding-down operation of the shutter button 41a is performed more frequently than the full-holding-down operation of the shutter button 41a, the number of sampling of the hand tremor tendency information can be increased compared to the case in which the hand tremor tendency information of the photographer is obtained from the hand tremor before and after the full-holding-down operation. Therefore, by judging whether the hand tremor tendency of the photographer is that of skilled photographer or that of unskilled photographer based on the hand tremor tendency information sampled many times, the accuracy of judgment is improved, and the optimum shooting process for shooting an image with no jitter can be selected from the first shooting process and the second shooting process.

Specifically, in the case of judging the hand tremor tendency of the photographer, it is possible to apply a method of simply adopting the most frequent hand tremor tendency information out of the hand tremor tendency information sampled many times, a method of adopting the most frequent hand tremor tendency information out of the latest (the latest period of time or the latest few samples of) hand tremor tendency information, or a method of providing the heavier density to the later information and adopting the hand tremor tendency information with the highest density. By adopting the method described above, even in the case, for example, the photographer, who is actually a skilled photographer, accidentally shows the same hand tremor tendency as unskilled photographers, it becomes possible to more reliably avoid misjudging the photographer as an unskilled photographer.

Further, since in the case in which the hand tremor tendency is the tendency β of skilled photographers, the shooting is performed immediately with the timing with which the hand tremor tendency has converged in the present embodiment, it becomes possible to shoot a less jittery image with proper shooting conditions while controlling the time lag. Further, since in the case in which the hand tremor tendency of the photographer is the tendency α1 of unskilled photographers, the shooting is immediately performed with the shooting conditions allowing avoidance of the jitter, it becomes possible to shoot a less jittery image without a time lag.

It should be noted that although in the present embodiment, the case in which the tremor after the semi-holding-down operation of the shutter button 41a is detected and frequency analysis of the detected tremor is performed is described, what is important is to perform the frequency analysis of the tremor in the state in which the photographer sets the camera ready, by detecting at least one of tremor during the operation (including semi-holding-down and full-holding down) of the shutter button 41a and performing the frequency analysis, it is possible to judge whether the photographer is a skilled photographer or an unskilled photographer.

Each of the embodiments described above is absolutely for showing an aspect of the invention, and can arbitrarily be modified or applied within a scope of the invention. For example, although in each of the embodiment described above, the case in which the invention is applied to the digital camera 10 is exemplified, this is not a limitation, but the point is that the invention can be widely applied to apparatuses in which the hand tremor causes a problem, and can be applied to a photographic device provided with a still image shooting function or a moving image shooting function besides the digital camera. Further, it is also possible to put the invention into practice by providing a photographic device implementing the invention to an electronic apparatus. Specifically, the invention can be applied to a camera-equipped cellular phone, a silver salt camera, a camera-equipped or camera-attached PDA or laptop PC.

Still further, although in each of the embodiments, the case for detecting the hand tremor in the vertical direction (X axis) and the horizontal direction (Y axis) is exemplified, the hand tremor in the depth direction (Z axis) can additionally be detected, or the hand tremor only in one of the above directions can also be detected.

1. A photographic apparatus comprising:
a shooting section for performing shooting based on an operation of an operation part for instructing shooting;
a tremor detection section for detecting a tremor amount of the shooting section; and
a shooting control section for causing detecting of the tremor amount by the tremor detection section at least one of before and after an operation of the operation part, specifying a hand tremor tendency of a photographer based on the tremor amount, and instructing the shooting section to execute shooting process in accordance with the specified hand tremor tendency.

2. The photographic apparatus according to claim 1, wherein:
the shooting control section compares the tremor amount before the operation of the operation part with a predetermined threshold value, and specifies whether the hand tremor tendency of the photographer is a converging tendency in accordance with a result of the comparison.

3. The photographic apparatus according to claim 1, wherein:
the shooting control section compares the tremor amounts before and after the operation of the operation part with each other, and specifies whether the hand tremor tendency of the photographer is a converging tendency in accordance with a result of the comparison.

4. The photographic apparatus according to claim 1, wherein:
the photographic apparatus stores information representing the specified hand tremor tendency of the photographer; and
the shooting control section, instructs an execution of the shooting process in accordance with the hand tremor tendency in the stored information.

5. The photographic apparatus according to claim 1, wherein:
in response to specifying that the hand tremor tendency of the photographer is a converging tendency, and in response to the tremor amount after the operation of the operation part reaching near the tremor amount before the operation of the operation part, the shooting control section instructs the shooting section to execute shooting.

6. The photographic apparatus according to claim 1, wherein:
in response to specifying that the hand tremor tendency of the photographer is a non-converging tendency, the shooting control section obtains shooting conditions that are set one of automatically and manually, and shooting conditions capable of reducing the effect of the tremor, and instructs the shooting section to perform shooting with severer shooting conditions out of the obtained shooting conditions.

7. The photographic apparatus according to claim 1, wherein:
the shooting control section further comprises:
a hand tremor tendency specifying section for specifying the hand tremor tendency of the photographer based on the tremor amount before the operation of the operation part; and
a storage section for pre-storing hand tremor tendency information for representing the hand tremor tendency of the photographer; and
the photographic apparatus is adapted to select a first priority mode and a second priority mode,
wherein:
in the first priority mode, the hand tremor tendency information stored in the storage section is given priority over the specifying result of the hand tremor tendency specifying section, and the shooting process is executed in accordance with the hand tremor tendency represented in the hand tremor tendency information; and
in the second priority mode, the specifying result of the hand tremor tendency specifying section is given priority over the hand tremor tendency information stored in the storage section, and the shooting process is executed in accordance with the hand tremor tendency represented by the specifying result.

8. The photographic apparatus according to claim 7, further comprising:
a hand tremor tendency information generation section for comparing the tremor amounts before and after the operation of the operation part with each other to specify the hand tremor tendency of the photographer, and for pre-generating the hand tremor tendency information.

9. The photographic apparatus according to claim 7, wherein:
the hand tremor tendency is categorized into at least two tendencies:
a first hand tremor tendency wherein the hand tremor of the photographer converges on a tremor amount so small as to cause no conspicuous jitter on a shot image after operation of the operation part; and
a second hand tremor tendency wherein the hand tremor of the photographer does not converge on a tremor amount so small as to cause no conspicuous jitter on a shot image after operation of the operation part.

10. The photographic apparatus according to claim 9, wherein:
in response to the hand tremor tendency of the photographer being a first hand tremor tendency, shooting is commenced in response to the tremor amount that has converged after the operation of the operation part.

11. The photographic apparatus according to claim 9, wherein:
in response to the hand tremor tendency of the photographer being a second hand tremor tendency, shooting is commenced with shooting conditions including exposure time, aperture value, and sensitivity changed to shooting conditions hardly causing jitter on the shot image.

12. The photographic apparatus according to claim 1, wherein:
the shooting section performs automatic focus adjustment in response to a semi-holding-down operation of the operation part, and performs a shooting process after a full-holding-down operation of the operation part; and
the shooting control section obtains by the tremor detection section a tremor amount at least one of before and after the semi-holding-down operation of the operation part, specifies the hand tremor tendency of the photographer based on the tremor amount, and in response to the full-holding-down of the operating part, instructs the shooting section to perform a shooting process in accordance with the specified hand tremor tendency.

13. The photographic apparatus according to claim 12, wherein:
the shooting control section compares the tremor amounts before and after the semi-holding-down operation of the operation part with each other, and specifies whether the hand tremor tendency of the photographer is a converging tendency in accordance with a result of the comparison.

14. The photographic apparatus according to claim 13, wherein:
the shooting control section judges the hand tremor tendency of the photographer to accumulate information representing the hand tremor tendency every semi-holding-down operation of a shutter button and specifies the hand tremor tendency of the photographer based on the accumulated information.

15. The photographic apparatus according to claim 1, wherein:
the shooting control section judges whether there is a tremor having an amplitude greater than a predetermined amplitude within a predetermined frequency range in the tremor detected by the tremor detection section, specifies the hand tremor tendency of the photographer based on the judgment result, and instructs the shooting section to perform a shooting process in accordance with the specified hand tremor tendency.

16. The photographic apparatus according to claim 15, wherein:
the shooting control section judges whether there is a constant tremor with an amplitude greater than a predetermined amplitude approximately equal to 10 Hz.

17. The photographic apparatus according to claim 15, wherein:
the shooting control section specifies whether the hand tremor tendency of the photographer is a converging tendency, in response to specifying that the hand tremor tendency of the photographer is a converging tendency, and in response to the tremor amount after the operation of the operation part reaching near the tremor amount before operation of the operation part, instructs the shooting section to execute shooting.

18. The photographic apparatus according to claim 15, wherein:
the shooting control section specifies whether the hand tremor tendency of the photographer is a converging tendency, in response to specifying that the hand tremor tendency of the photographer is a non-converging tendency, obtains shooting conditions that are set one of automatically and manually, and shooting conditions capable of reducing an effect of the tremor, and instructs the shooting section to perform shooting with severer shooting conditions out of the obtained shooting conditions.

19. A method of controlling a photographic apparatus comprising:
detecting a tremor amount at least one of before and after an operation of an operation part for instructing shooting; and
specifying a hand tremor tendency of a photographer based on the tremor amount to perform a shooting process in accordance with the specified hand tremor tendency.

20. A computer readable recording medium recording a program for instructing a computer including a shooting section for performing shooting based on an operation of an operation part for instructing shooting to function as:
tremor detection means for detecting a tremor amount of the shooting section; and
shooting control means for causing detecting of the tremor amount by the tremor detection means at least one of before and after an operation of the operation part, specifying a hand tremor tendency of a photographer based on the tremor amount, and instructing the shooting section to execute a shooting process in accordance with the specified hand tremor tendency.
